(19) United States
(12) Patent Application Publication
(10) Pub. No.: US 2004/0227741 A1
(43) Pub. Date: Nov. 18, 2004

(54) Instruction inputting device and instruction inputting method

(75) Inventors: Yasunori Koda, Ashigarakami-gun (JP); Hiroyuki Hotta, Ebina-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/754,706

(22) Filed: Jan. 12, 2004

(30) Foreign Application Priority Data
May 16, 2003 (JP) 2003-138645

(51) Int. Cl. G09G 3/22; G09G 3/32

(52) U.S. Cl. 345/183; 345/82

(57) ABSTRACT

An instruction inputting device and instruction inputting method which improve usability without requiring mechanical control or relatively fine control. Three-dimensional positional information of an LED, which is mountable on a person inputting instructions, is measured by a 3D measurement device in accordance with reception conditions of light emitted from the LED, and then is input to the device. On the basis of the acquired 3D positional information, velocities and accelerations relating to movement of the LED are detected. On the basis of the detected velocities and accelerations, it is decided whether or not movement of the-LED corresponds to pre-specified movement. When it is decided that the movement of the LED corresponds to any of the pre-specified movement, execution of processing associated with that pre-specified movement is instructed.

### CROSS-REFERENCE TO RELATED APPLICATION

This application claims priority under 35USC 119 from Japanese Patent Application No. 2003-138645, the disclosure of which is incorporated by reference herein.

### BACKGROUND OF THE INVENTION

1. Field of the Invention

The present invention relates to an instruction inputting device and an instruction inputting method, and particularly relates to an instruction inputting device and instruction inputting method for inputting instructions in accordance with positional information of a light-emitting component.

2. Description of the Related Art

As devices for inputting instructions to personal computers and the like, two-dimensional mouses have been widely used heretofore. A two-dimensional mouse inputs x-y co-ordinate to a personal computer as instructions in the form of relative co-ordinate. Recently, several technologies have been proposed to input values in the three-dimensions using such two-dimensional mouses.

For example, an LED, which serves as a light-emitting body, is mounted on a user's finger, and a light-receiving device, which receives light from the LED, is attached on the top of a personal computer's monitor. Thus, a three-dimensional mouse can be realized simply (see, for example, Japanese Patent Application Laid-Open (JP-A) No. 10-9812). Sensors that are employed herein acquire angles of a light source relative to the sensors, and a three-dimensional position of the light source is obtained by the principle of triangulation. Power for the LED light source is supplied from the personal computer, and clicking signals and the like, which are basic operations of a mouse, are sent to operating system of the personal computer by wire. Specifically, a switch which can be pressed with a finger is mounted near the light-emitting body.

Further, there is a pointing device which by rotating two balls in the two-dimensions, can input not only the values of its movement in the x-axis direction and y-axis direction, but also angles, rotation angles and the like, and furthermore can input values in the z-axis direction (see, for example, JP-A No. 5-150900). Also known is a non-contact type position detection device (see, for example, JP-A No. 11-24832), which generates signals in accordance with changes in output of both of the first sensor array, in which photosensitive sensors are arrayed in the first direction, and the second sensor array, in which photosensitive sensors are arrayed in the second direction which is different from the first, while they are moving, and accordingly determines the amount and directions of movement (of a cursor or the like).

Further known are: a remote control device which detects movement of an finger with a CCD camera and interprets it as a command for a personal computer or the like (see, for example, JP-A No. 11-110125); an electric pen for inputting co-ordinate, which is provided by a rotary switch which is rotatable by a finger, and in turn, the rotation of which determines a degree of change of graphical parameters (such as thickness of a line, color, shading or grayscale level) (see for example, JP-A No. 2000-47805); and an instruction inputting system which detects movement of an RFID (radio frequency identification) tag mounted on a user's wrist and hence interprets patterns of movement of the RFID tag as commands for input to another device (see, for example, JP-A No. 2001-306235); and so forth.

Further yet, GYROMOUSE PRESENTER, from the GYRATION corporation of America, is a pointing device, which incorporates an auto-gyro and can change a direction of a laser in the air. However, weight thereof is comparatively large, size thereof is also comparatively large (because of the gyro), and the device is somewhat high in price.

In recent years, by applying the idea of half-pressing used for camera shutter operations, a prototype of a keyboard on which a notepad is overlaid, henceforth, it possesses a characteristic wherein characters are inputted only when corresponding keys are pushed strongly, has been developed.

Meanwhile, a present applicant has proposed a three-dimensional instruction inputting device which can notify a user how a light-emitting component passes through the boundaries of regions comprising the three-dimensional space in front of a monitor by feeding back mechanism on at least one of the five senses (a focus metaphor, variations in color tone or the like). This device, thus, can execute functions of a two-dimensional mouse, such as clicking, double-clicking, dragging and the like, in accordance with operations of passing the light-emitting component through a boundary in a way corresponding to a respective function, without utilizing a mechanical mechanism.

However, the conventional three-dimensional mouse described is operated by pressing a switch mounted near the light-emitting body with a finger. Therefore, similarly to aforementioned two-dimensional mouse, mechanical operations and corresponding components for realizing such operations are required. Furthermore, the same applies to other instruction inputting devices, such as the conventional pointing devices, aforementioned instruction inputting systems and the like.

Furthermore, with GYROMOUSE PRESENTER by the GYRATION corporation of America, operations for clicking and the like also require mechanical operations with fingers, like ordinary two-dimensional mouses. Further yet, the same applies to a device where a notepad is overlaid on its keyboard.

Thus, because conventional instruction inputting devices require relatively fine operations for pressing buttons, switches and the like, usability thereof is comparatively poor for those who may have a difficulty to perform mechanical operations.

Further again, because the three-dimensional space is divided into the plurality of regions, whose boundaries are fixed in the three-dimensional space with the three-dimensional instruction inputting device that has been proposed by the present applicant, it is necessary for a user to move a hand, finger or the like on which the light-emitting component is mounted, to positions along respective boundaries; thus, in order to recognize the respective boundaries fine operations of controllings a finger or a hand is required.

### SUMMARY OF THE INVENTION

The present invention has been devised in consideration of the circumstances described above, and an object of the present invention is to provide an instruction inputting device and instruction inputting method which can improve usability without requiring mechanical operations or relatively fine operations.

In order to achieve the object described above, an instruction inputting device of the present invention comprises: an input component which inputs positional information of a light-emitting component, where positional information is measured on the basis of the reception status for light emitted from the light-emitting component, the light-emitting component being mountable on a part of user's physical body; a detection component which, on the basis of the positional information on the input, detects a physical quantity of speed in accordance with movement of the light-emitting component; a decision making component which, on the basis of the physical quantity of the aforementioned speed, decides whether or not the movement of the light-emitting component corresponds to pre-specified movement; and an instruction component which, if it is decided that the movement of the light-emitting component corresponds to the pre-specified movement, issues a command to execute a corresponding processing.

The light-emitting component is mountable on a part of user's physical body, preferably mounted on a finger, a hand or the like. The light-emitting component is not limited to a particular device as long as it emits light, and may be, for example, an LED. The present invention detects positional information on the light-emitting component in accordance with the reception status of the emitted light.

The input component inputs the positional information on the light-emitting component. The positional information may be, for example, three-dimensional positional information such as information on positions along the x-axis, y-axis and z-axis, and could be only one thereof such as, for example, information on position along the z-axis.

Based on the positional information given by the input component, the detection component detects the physical quantity of speed on the movement of the light-emitting component.

Based on the physical quantity of speed detected by the detection component, the decision making component decides whether or not the movement of the light-emitting component corresponds to pre-specified movement. For example, a threshold for the physical quantity of speed may be specified in advance, such that it is decided that the movement of the light-emitting component corresponds to the pre-specified movement when this threshold is exceeded.

Note that there may be one pre-specified movement, or there may be a plurality thereof. Furthermore, movement may comprise several smaller movement.

When it is decided by the decision making component that the movement of the light-emitting component corresponds to pre-specified movement, the instruction component issues a command to execute a predefined process corresponding to the pre-specified movement.

Thus, according to the present invention, instructions can be input without requiring mechanical operations or relatively fine operations.

The instruction inputting device relating to the present invention further have a storage component which stores information on the pre-specified and distinct movements, and the aforementioned decision making component may include: a selection component which selects information on at least one movement that corresponds to movement of the light-emitting component from the aforementioned information in the storage component; and a verification component which verifies whether or not the movement of the light-emitting component corresponds to the movement selected by the selection component.

The storage component stores the movement information consisting of several distinct and pre-specified movements. This movement information is not particularly limited to a particular information, and may be, for example, information, which characterizes the pre-specified movement. The storage component may be, for example, a volatile memory, and may be a non-volatile memory.

The decision making component may be equipped with the selection component and the verification component. From the information of the plurality of movement that is stored in the storage component, the selection component selects one or more movement in accordance with the movement of the light-emitting component. The verification component verifies whether or not the movement of the light-emitting component corresponds to movement information selected by the selection component.

The movement information of the present invention may include information of a time series of positions, and the aforementioned input component may input the positional information as a time series, and the selection component may select the information of at least one movement on the basis of the positional information that has been input to the time series.

The information of a time series of positions includes, for example, information on positions along the time axis. The input component may input the positional information as a time series by, for example, inputting positional information at predetermined time intervals. The selection component may select the information of one or more movement on the basis of the positional information input to the time series and, for example, at the time of selection, compare the movement information with the selected pre-specified movement information.

The verification component of the present invention may verify whether or not the movement of the light-emitting component corresponds to movement represented by the movement information selected at the selection component on the basis of the detected physical quantity of speed.

The physical quantity relating to speed of the present invention may include at least one of acceleration and velocity of the movement of the light-emitting component.

The instruction inputting device relating to the present invention may further include: a display component which displays information of a target for which execution of processing is to be instructed and designation information for designating the target information; and a display control component which controls the display component such that a position of the designated information changes in accordance with a change of the positional information of input. The aforementioned instruction inputting device may issues a command to execute the processing corresponding to the pre-specified movement for the target information that is designated by the designation information when it is decided that the movement of the light-emitting component corresponds to the pre-specified movement.

The display component displays the target information to which a command to execute a process is to be issued and the designation information for designating the target information. The display component is not limited to a particular device as long as it displays desired information. The display component may be a television monitor, a personal computer's monitor or the like, and could be a touch panel on a PDA or the like. If the display component is a monitor provided at a personal computer or the like, the target information for which execution of processing is to be instructed may be an icon, a folder or the like, or simply positional information of input. Furthermore, the an input device for specifying the target information may be, for example, a cursor that is employed by a personal computer.

The display control component controls the display component so as to change a position of the designation information in accordance with changes of positional information by, for example, changing the position of a cursor.

If it is decided that the movement of the light-emitting component corresponds to pre-specified movement, the instruction component of the processing corresponding to the pre-specified movement, to be applied to the target information that is designated by the designation information.

The instruction component of the present invention may instruct execution of the processing corresponding to pre-specified movement, for the target information that is designated by the designation information, using the movement of the light-emitting component for which it has been decided that the movement of the light-emitting component corresponds to the pre-specified movement.

For example, when positional information of the light-emitting component changes according to the movement of the light-emitting component, the position of the designating information could change, in accordance with the change in the positional information of the light-emitting component. For example, in a case in which the designating information is a cursor employed by a personal computer, the position of the cursor on the display could change and the target information designated by the cursor at the starting point and the finishing point of the movement of the light-emitting component may be different. In such a case, it may be pre-specified which target information an instruction for executing the process associated with the pre-specified movement should designate.

The pre-specified movement of the present invention may include movement of reciprocating once in a predetermined direction. This movement may be treated as, for example, a clicking movement performed with a personal computer mouse.

The pre-specified movement of the present invention may include: the movement which reciprocates once in a predetermined direction, within a predetermined duration, with a calculation component which calculates the duration of the movement of the aforementioned light-emitting component, and the aforementioned decision making component deciding whether or not the movement of the light-emitting component is the pre-specified movement on the basis of the detected physical quantity of speed and the duration calculated by the calculation component.

The pre-specified movement of the present invention may include movement of reciprocating twice in a predetermined direction. This movement may be treated as, for example, a double-clicking movement performed with a personal computer mouse.

The pre-specified movement of the present invention may include the movement of reciprocating twice in a predetermined direction, within predetermined duration, with the calculation component which calculates the duration of the movement of the aforementioned light-emitting component, and the decision making component deciding whether or not the movement of the light-emitting component is the pre-specified movement on the basis of the detected physical quantity of speed and the duration calculated by the calculation component.

The pre-specified movement of the present invention may include movement which moves in a predetermined direction and, after moving in the predetermined direction, further moves in at least one of the predetermined directions, the direction perpendicular to the aforementioned predetermined direction and a direction between these aforementioned two directions. This movement may be treated as, for example, a dragging movement performed with a personal computer mouse.

The pre-specified movement of the present invention may include the movement which moves in a predetermined direction and, after moving in a predetermined direction, further, after a predetermined duration has passed, moves in the at least one of the predetermined direction, the direction perpendicular to the aforementioned predetermined direction and a direction between these aforementioned two directions. The present invention may be equipped with the calculation component which calculates duration of the movement of the light-emitting component, and with the decision making component deciding whether or not the movement of the light-emitting component is the pre-specified movement on the basis of the detected physical quantity of speed and the duration calculated by the calculation component.

The pre-specified movement of the present invention may include movement, which moves in reverse to a predetermined direction. This movement may be treated as, for example, dropping movement performed with a personal computer mouse.

The pre-specified movement of the present invention may include a state of being quiescent.

The pre-specified movement of the present invention may include the state of being quiescent, for predetermined duration, with the calculation component which calculates duration relating to the movement of the aforementioned light-emitting component, and the decision making component determining whether or not the movement of the light-emitting component includes the state of being quiescent for the predetermined duration on the basis of the detected physical quantity of speed and the duration calculated by the calculation component.

The present invention may include the calculation component which calculates duration relating to the movement regarding the light-emitting component, and the decision making component may decide whether or not the movement of the light-emitting component corresponds to pre-specified movement on the basis of the detected physical quantity of speed and the calculated duration.

Accordingly, the detected physical quantity of speed and the duration corresponding to the movement of the light-emitting component, which has been calculated by the calculation component, may be utilized as conditions for decision making on the movement of the light-emitting component.

The decision making component of the present invention may, when determining whether or not the movement of the light-emitting component corresponds to pre-specified movement, apply a tolerance to at least one of the movement of the light-emitting component and the pre-specified movement.

For example, when a user mounts the light-emitting component on his/her hand and moves the light-emitting component, undesired slight wobbling may occur due to the shaking of the hand. Accordingly, it is preferable that the decision making component decides either with the movement of the light-emitting component or with the pre-specified movement with a certain tolerance.

The display control component of the present invention may control so as to alter an expression of the designation information in accordance with the detected physical quantity of speed.

The display control component of the present invention may control so as to alter at least one of the figure, size and color of the designation information in accordance with the detected physical quantity of speed.

The display control component of the present invention may control so as to alter the size of information to be displayed within a predetermined distance from the position of the designation information.

The instruction inputting device regarding the present invention may further include: a sound generating component for generating sound; and a sound outputting control component which controls the aforementioned sound generating component so as to alter a sound generating condition in accordance with the detected physical quantity of speed.

Here, it is sufficient that any sound generating component may be used as long as it generates sound, and may be, for example, a loudspeaker.

An instruction inputting method regarding the present invention includes: a measuring step of measuring positional information on a light-emitting component on the basis of light-reception conditions of light emitted from the light-emitting component, which is mountable on an user; an input step of feeding the positional information measured in the measuring step; a detecting step of, on the basis of the aforementioned positional information on the input, detecting a physical quantity of speed in accordance with a movement of the light-emitting component; a decision step of, on the basis of the detected physical quantity of speed, deciding whether or not the movement of the light-emitting component corresponds to pre-specified movement; and an instructing step of, if it is decided that the movement of the light-emitting component corresponds to pre-specified movement, issuing a command to execute a process corresponding to the pre-specified movement.

According to the present invention, instructions can be input without requiring mechanical operations or relatively fine operations.

A program regarding the present invention executes, on a computer: an input step of inputting positional information of a light-emitting component which is measured on the basis of light-reception conditions of light emitted from the light-emitting component, which is mountable on a user; a detection step of, on the basis of the positional information on the input, detecting a physical quantity of speed in accordance with movement of the light-emitting component; a decision step of, on the basis of the detected physical quantity of speed, deciding whether or not the movement of the light-emitting component corresponds to pre-specified movement; and an instruction step of, if it is decided that the movement of the light-emitting component corresponds to the pre-specified movement, issuing a command to execute a process corresponding to the pre-specified movement.

When the program of the present invention is executed on a computer, instructions can be input without requiring mechanical operations or relatively fine operations.

A storage medium for storing this program is not limited to a particular device. The storage medium may be a hard disk, and may be a ROM. Further, CD-ROMs, DVDs, magneto-optical disks, IC cards and the like are also applicable. Further again, the program may be downloaded from a server connected to a network or the like.

As described above, the present invention decides whether or not the movement of a light-emitting component corresponds to pre-specified movement on the basis of a physical quantity of speed in accordance with the movement of the light-emitting component. In a case in which it is decided that the movement of the light-emitting component corresponds to the pre-specified movement, an instruction to execute a process corresponding to the pre-specified movement is given. Thus, the present invention provides a form of inputting method without any necessity for mechanical control or relatively fine control.

### BRIEF DESCRIPTION OF THE DRAWINGS

FIG. 1 is a diagram showing structure of an instruction inputting system which includes a personal computer that is provided with functionality as an instruction inputting device relating to the first embodiment of the present invention.

FIG. 2 is a diagram showing detailed structure of the personal computer.

FIG. 3 is a diagram showing functional structure of the personal computer.

FIG. 4 is a diagram showing examples of various instruction operations, such as clicking, double-clicking and drag-and-dropping, in detail.

FIG. 5 is a flowchart showing a main routine of an instruction inputting process, which is carried out by the CPU of the personal computer.

FIG. 6 is a flowchart showing the main routine of the instruction inputting process, which is carried out by the CPU of the personal computer.

FIG. 7 is a flowchart showing the main routine of the instruction inputting process which is carried out by the CPU of the personal computer.

FIG. 8 is a diagram showing an example of movement of an LED that corresponds to so-called double-clicking.

FIG. 9 is a flowchart showing a display processing routine.

FIG. 10 is a flowchart showing part of a main routine of an instruction inputting process of the second embodiment of the present invention.

FIG. 11 is a flowchart showing a processing routine which decides whether or not a positional information on input remains the same (i.e. being locked) in accordance with a process being executed, in the third embodiment of the present invention.

FIG. 12 is a flowchart showing part of the main routine of an instruction inputting process of the fourth embodiment of the present invention.

FIG. 13 is a flowchart showing the main routine of an instruction inputting process of the fifth embodiment of the present invention.

FIG. 14 is a flowchart showing a processing routine for storing positional information, in the sixth embodiment of the present invention.

FIG. 15 is a flowchart showing an instruction inputting processing routine for implementing an instruction inputting process, which utilizes a time series pattern, in the sixth embodiment of the present invention.

FIG. 16 is an example of a time-series pattern that represents a clicking operation.

FIG. 17 is an example of a time-series pattern that represents a double-clicking operation.

FIG. 18 is a diagram showing an example of velocity conditions in a clicking operation.

FIG. 19 is a diagram showing an example of velocity conditions in a double-clicking operation.

FIG. 20 is an example of a time-series pattern in the seventh embodiment of the present invention.

FIG. 21 is another example of a time-series pattern in the seventh embodiment of the present invention.

FIG. 22A is a diagram showing a state in which the size of an extended-cursor is enlarged and a magnification rate of an image within the extended-cursor is increased.

FIG. 22B is a diagram showing a state of the extended-cursor when velocity is not sufficient.

FIG. 23 is a flowchart showing a processing routine of the eighth embodiment of the present invention.

### DETAILED DESCRIPTION OF THE INVENTION

Hereinbelow, embodiments of the present invention will be described in detail with reference to the drawings.

### THE FIRST EMBODIMENT

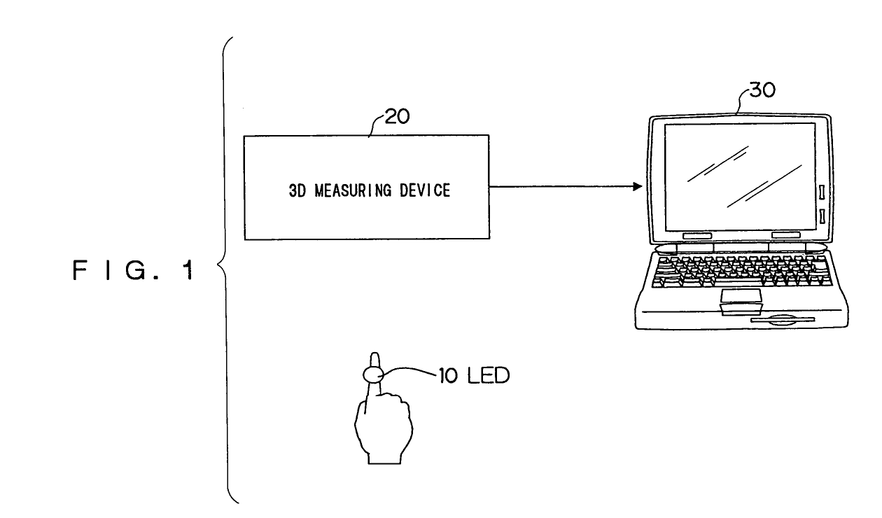

FIG. 1 is a diagram showing structure of an instruction inputting system which includes a personal computer 30, which is equipped with the function of inputting instructions relating to the first embodiment of the present invention.

As illustrated, the instruction inputting system is provided with an LED 10, a 3D measuring device 20, and the personal computer 30.

The LED 10 is mounted on a finger, hand or the like of a user.

The 3D measuring device 20 measures a position in the three-dimensions on the basis of light-reception conditions of light emitted from the LED 10.

This 3D measuring device 20 is not limited to a particular device, as long as it can measure a position in the three-dimensions based on light-reception conditions of light emitted from a light-emitting body such as the LED 10 or the like. The 3D measuring device 20 may be constructed utilizing the position detection technology described in Japanese Patent Application Laid-Open (JP-A) 10-9812 or the like.

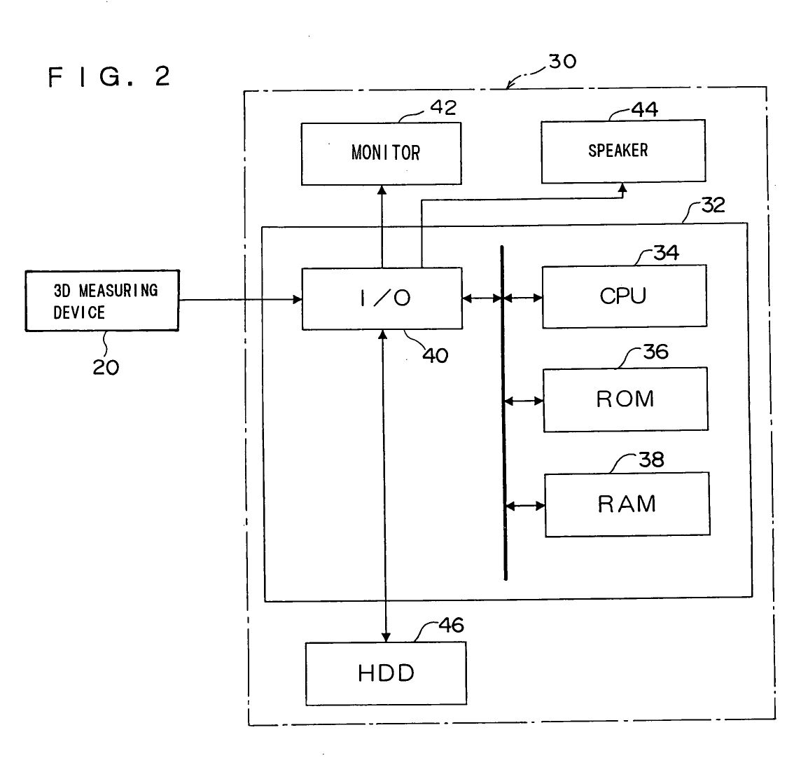

FIG. 2 is a diagram showing detailed structure of the personal computer 30.

As illustrated, the personal computer 30 comprises a personal computer main body 32, a CPU 34, a ROM 36, a RAM 38 and an input/output interface (I/O) 40. The I/O 40 is connected with the 3D measuring device 20, a display 42, a speaker 44, and a hard disk drive (HDD) 46.

A program of an instruction inputting processing routine for instructing an execution of predetermined processes in accordance with velocity and acceleration related to movement of the LED 10 (hereafter called an instruction inputting processing program), specification information for executing the instruction inputting processing program, and the like are stored in the HDD 46. The CPU 34 loads the instruction inputting processing program and the specification information into the RAM 38, and executes the program.

A storage medium for storing the instruction inputting processing program is not limited to the HDD 46, and the ROM 36 may be used for this purpose. ACD-ROM, DVD, magneto-optical disc, IC card or the like may be connected to the I/O 40. Further, the program may be downloaded from a server connected to a network or the like.

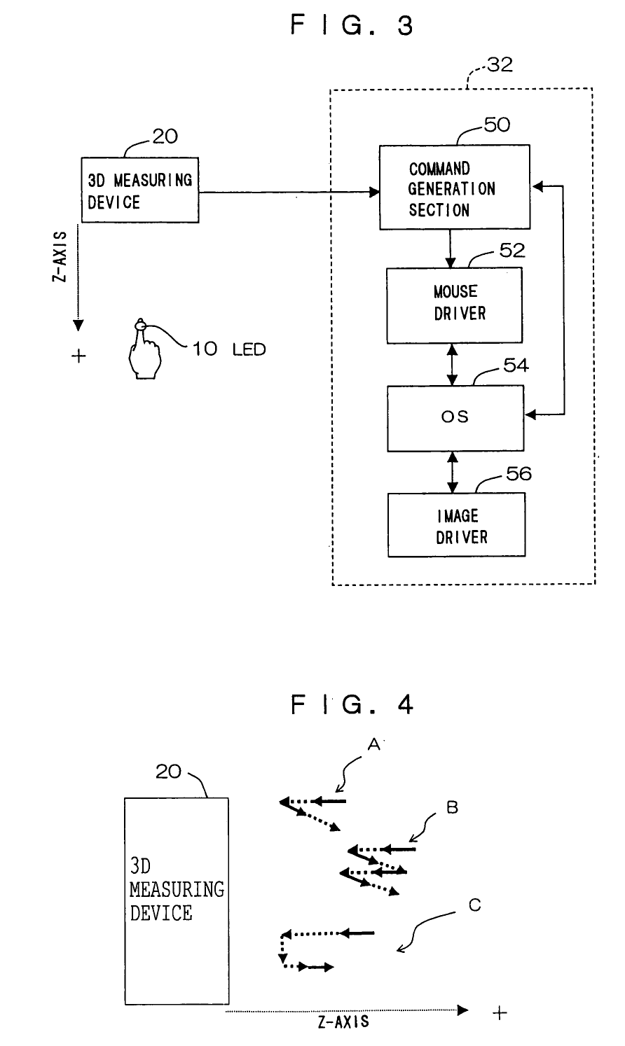

FIG. 3 is a diagram structurally illustrating the functionality of the personal computer's main body 32.

As illustrated, the personal computer main body 32 comprises a command generation section 50, a mouse driver 52, an OS 54 and an image driver 56.

The command generation section 50 inputs three-dimensional positional information that has been measured by the 3D measuring device 20, which detects velocity levels and acceleration levels in accordance with movement of the LED 10. On the basis of the detected velocity and acceleration, the command generation section 50 determines whether the movement of the LED 10 is movement that corresponds to one of button operations of an ordinary mouse equipped with a button (hereafter called a two-dimensional mouse) such as clicking, double-clicking and drag-and-dropping. The command generation section 50 generates a command in accordance with results of this decision, and outputs the command to the mouse driver 52.

FIG. 4 is a diagram showing examples of instruction set: a clicking, a double-clicking and a drag-and-dropping, in detail.

Here, a direction from the 3D measuring device 20 toward the hand of a user is defined to be the z-axis, and a plane perpendicular to the z-axis is an x-y plane defined by the x-axis and the y-axis. Thus, an xyz co-ordinate system is defined. Along the z-axis, a direction away from the 3D measuring device 20 is defined to be the positive direction.

If a monitor of the display 42 of the personal computer 30 coincides with the position of the 3D measuring device 20, a z co-ordinate is the distance from the monitor, and the monitor can be regarded as the x-y plane.

In the present embodiment, clicking movement is specified as movement which moves rapidly in a direction toward the 3D measuring device 20 (a minus direction of the z axis) and then moves backward rapidly in an opposite direction (a plus direction of the z axis) within pre-specified time duration (in other words, a single reciprocation along the z axis), and corresponds to the movement A in the drawing.

Double-clicking movement is specified as movement in which clicking movement is consecutively repeated twice (in other words, double reciprocations along the z axis), and corresponds to the movement B in the drawing.

A drag-and-dropping movement is constituted of dragging movement and dropping movement, and corresponds to the movement C in the drawing. The dragging is specified as movement which rapidly moves in the minus direction of the z-axis and then, after a pre-specified amount of time has passed, moves slowly along the x-y plane as well as in the minus direction of the z axis. Note that there is no limit on time duration for the slow movement specified above. The dropping is specified as movement, which moves rapidly in the plus direction of the z-axis.

In the personal computer 30, thresholds of velocity and acceleration relating to these movement (in the present embodiment, V₀ and A₀) are specified as absolute values, and thresholds of time duration relating to the movement (in the present embodiment, T1₀ and T2₀) are also specified. The command generation section 50 compares the detected velocities and accelerations with the specified thresholds of velocity and acceleration and compares the time duration relating to the movement of the LED 10 with the specified thresholds of time duration, and decides whether or not the movements of the LED 10 correspond to the pre-specified movements described above.

By utilizing the value of acceleration, it is possible to distinguish between the state in which the LED 10 is moved rapidly, and the state in which this is not so, that is, between the state in which the user intentionally moves the hand and the state in which the user moves the hand randomly without intending to input an instruction.

Further, by utilizing the value of velocities, it is possible to determine, when the LED 10 has been moved by a certain distance, the actual movement of the LED 10. Based on the velocities, it is possible to recognize smaller movement than that which is calculated from moving distance in the three-dimensional space.

Note that in FIG. 4, acceleration states are shown by arrows of solid line, and velocity states are shown by arrows of broken line.

The mouse driver 52 inputs commands from the command generation section 50 and outputs commands to the OS 54.

The OS 54 interprets the commands that have been input from the mouse driver 52, and executes processes in accordance with the commands.

The image driver 56, under the control of the OS 54, carries out a process for displaying images on the display 42 in accordance with the movement of the LED 10.

A sound driver is also provided at the personal computer main body 32. Under the control of the OS 54, the sound driver carries out processing for generating sounds at the speaker 44 in accordance with the movement of the LED 10.

Now, an instruction inputting process of the present embodiment will be described.

A user moves his/her hand on which the LED 10 is mounted in front of the 3D measuring device 20 (i.e., in a light-reception region). The position of the LED 10 changes in accordance with movement of the hand. The 3D measuring device 20 detects the position of the LED 10 in the three-dimensions at predetermined time intervals. The 3D measuring device 20 successively outputs the three-dimensional positional information of the LED 10 to the personal computer 30.

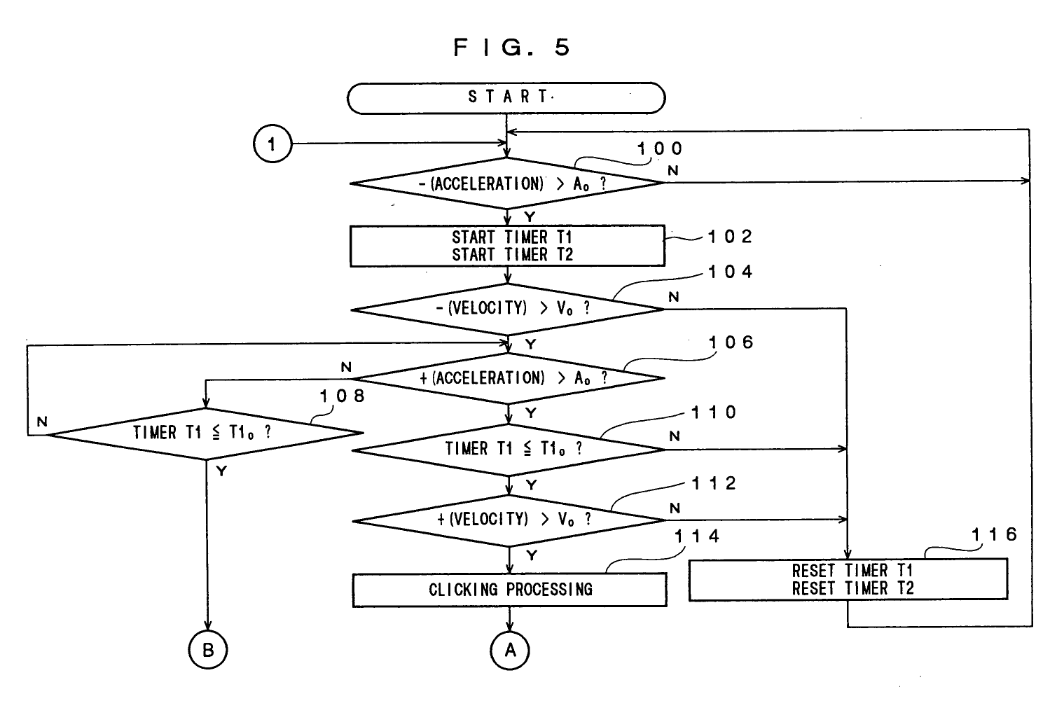

FIGS. 5 to 7 are flowcharts, which show the main routine of instruction input processing, which are carried out by the CPU 34 of the personal computer 30.

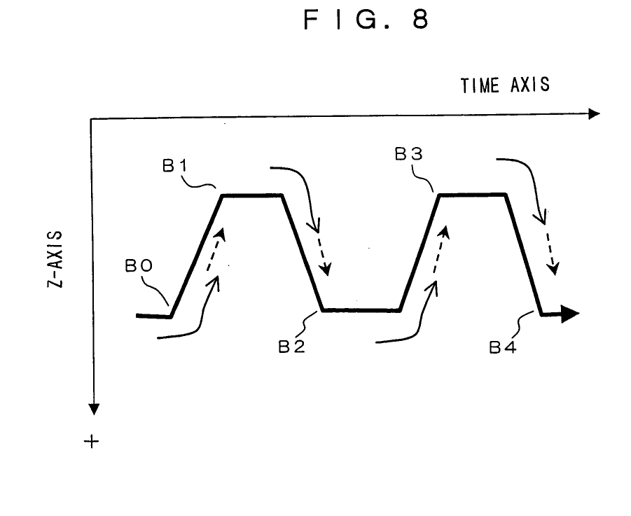

FIG. 8 is a diagram showing an example of movement of the LED 10 corresponding to double-clicking movement.

In FIG. 8, the horizontal axis is the time axis, and the vertical axis is the z-axis. The thick line shown with points B0 to B4 represents a path of movement of the LED 10. The thin solid line arrows represent acceleration states, and the broken line arrows represent velocity states.

The movement along the time axis of the LED 10 shown by the thick line and the accelerations and velocities corresponding to these movement are extremely small in reality, but are exaggeratedly drawn in the FIG. 8.

Below, the instruction inputting process will be described using the flowcharts in FIGS. 5 to 7, referring to FIG. 8.

The personal computer 30 inputs three-dimensional positional information on the LED 10 from the 3D measuring device 20 at predetermined time intervals. Then, at each time of input, the personal computer 30 detects a velocity and an acceleration relating to the movement of the LED 10 on the basis of the acquired three-dimensional positional information. In the present embodiment, the personal computer 30 uses z co-ordinate, which are included in the aforementioned three-dimensional positional information, to detect velocity and acceleration along the z-axis.

The velocity can be detected, for example, by dividing a difference between z co-ordinates of the three-dimensional positional information by a corresponding time difference, and the acceleration can be detected by dividing the change of the velocities by a corresponding time difference. Note that, because the direction away from the 3D measuring device 20 is the plus direction of the z axis, the sign of velocity and acceleration values is “+” when the LED 10 is moving in the direction away from the 3D measuring device 20, and the sign of velocity and acceleration values is “−” when the LED 10 is moving in the direction of approaching the 3D measuring device 20.

At the step 100 of the flowchart of FIG. 5, it determines whether or not a value is greater than the acceleration threshold A₀ (a negative sign is put in order to make the value positive).

As described above, the sign of the velocity and acceleration is minus when the LED 10 is moved in the direction approaching the 3D measuring device 20. Therefore, in such a case, the velocity and acceleration are made to be positive by applying a minus sign. When the LED 10 is moved in the direction away from the 3D measuring device 20, the velocity and acceleration are made to be negative by applying the minus sign. As mentioned earlier, the threshold V₀ and the threshold A₀ are specified as absolute values.

Therefore, by determining whether or not the value of acceleration to which the minus sign has been applied is greater than the threshold A₀, it can be decided whether or not the LED 10 is being moved in the direction toward the 3D measuring device 20.

If it is determined at the step 100 that the negated value of acceleration is less than or equal to A₀, a waiting state is maintained until the next three-dimensional positional information is input from the 3D measuring device 20. In FIG. 8, the state prior to the point B0 corresponds to this waiting state.

If it is determined that the negative value of acceleration is greater than A₀ (corresponding to the point B0 in FIG. 8), this is a state in which the user is intentionally moving the hand. Accordingly, the process advances to the step 102, initiating the timer T1 and the timer T2.

Here, the timer Ti measures duration from the commencement of movement in one direction until the commencement of movement in the reverse direction. A threshold T1₀ is specified for the timer T1 beforehand.

The timer T2 is a timer to decide whether or not the movement of LED is double-clicking. A threshold T2₀ is specified for the timer T2 beforehand.

At the step 104, it is determined whether or not a negative value of the velocity exceeds the threshold V₀. Similarly to the acceleration, a minus sign is applied to the velocity and then it is compared with the threshold value V₀.

If, at the step 104, it is determined that the negated velocity is less than or equal to V₀, the process advances to the step 116, the timers T1 and T2 are reset, and the process returns to the waiting state.

If, at the step 104, it is determined that the negated velocity is greater than V₀ (corresponding to the point Bi in FIG. 8), the process advances to the step 106 and it is determined whether or not the acceleration exceeds the threshold A₀. Note that here a positive sign is put in front of the term, “acceleration”, in order to clarify the direction of movement of the LED 10, for the sake of convenience.

If, at the step 106, it is determined that the positive acceleration is less than or equal to A₀, the process advances to the step 108, and it is determined whether or not the timer T1 has exceeded the threshold value T1₀. Here, if it is determined that the timer T1 is less than or equal to T1₀, the process returns to the step 106, and a velocity and an acceleration based on the next three-dimensional positional information to be input from the 3D measuring device 20 are detected and the process continues.

If, at the step 106, it is determined that the positive acceleration is greater than A₀, the process advances to the step 110, and it is determined whether or not the timer T1 is less than or equal to the threshold T1₀.

If, at the step 110, it is determined that the timer T1 is greater than T1₀, the movement of the LED 10 does not correspond to any of the pre-specified movement. Accordingly, the process advances to the step 116, the timers T1 and T2 are reset, and the process returns to the waiting state. If, at the step 110, it is determined that the timer T1 is less than or equal to T1₀, the movement of the LED 10 does not exceed the pre-specified time duration. Accordingly, the process advances to the step 112, and it is determined whether or not the velocity exceeds the threshold V₀.

If, at the step 112, it is determined that the (positive) velocity is less than or equal to V₀, the movement of the LED 10 does not correspond to any of the pre-specified movement. Accordingly, the process advances to the step 116, the timers T1 and T2 are reset, and the process returns to the waiting state. If it is determined that the positive velocity is greater than V₀, the movement of the LED 10 corresponds to the pre-specified clicking movement described earlier. Accordingly, the process advances to the step 114, and the process for clicking is carried out (this corresponds to the point B2 in FIG. 8).

Description is now given in detail using the functional diagram of FIG. 3. The command generation section 50 outputs a command to the mouse driver 52 for instructing an execution of a process in response to clicking movement. The command generation section 50 outputs the command in the same format as a command caused by a button operation with a two-dimensional mouse. Therefore, the OS 54, to which the command is input via the mouse driver 52, can interpret the command in the same way as in the case of a two-dimensional mouse, and executes suitable processing.

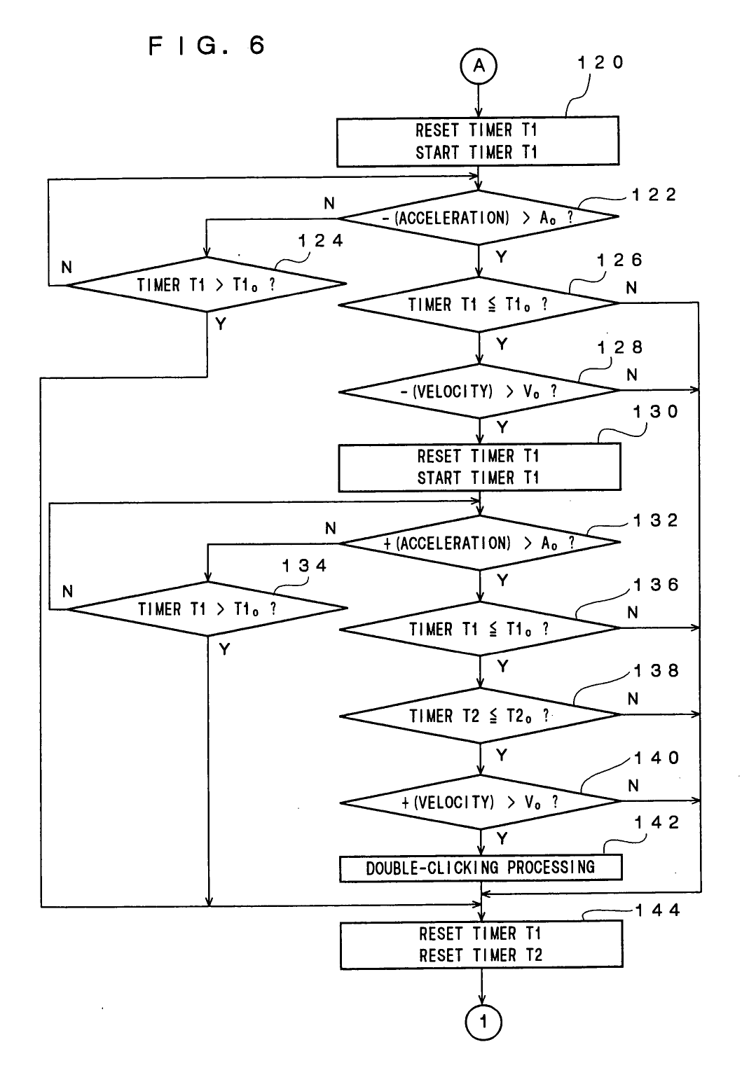

After the clicking process of the step 114 has been executed, the process advances to the step 120 in FIG. 6, and the timer T1 is reset and started again. Processing subsequent to this step is a process to decide whether or not the movement of the LED 10 is double-clicking.

At the step 122, it is determined whether or not a negated value of the acceleration exceeds the threshold A₀. If it is determined that the negated acceleration is less than or equal to A₀, the process advances to the step 124 and then it is determined whether or not the timer T1 has exceeded the threshold T1₀.

If, at the step 124, it is determined that the timer T1 is greater than T1₀, the process advances to the step 144, the timers T1 and T2 are reset, and the process returns to the waiting state. If, at the step 124, it is determined that the timer T1 is less than or equal to T1₀, the process returns to the step 122, and a velocity and an acceleration based on the next three-dimensional positional information to be input from the 3D measuring device 20 are detected and the process continues.

If, at the step 122, it is determined that the negated value of acceleration is greater than A₀, the process advances to the step 126, and it is determined whether or not the timer T1 is less than or equal to the threshold T1₀.

If, at the step 126, it is determined that the timer T1 is greater than T1₀, the process advances to the step 144, the timers T1 and T2 are reset, and the process returns to the waiting state. If, at the step 126, it is determined that the timer T1 is less than or equal to T1₀, the process advances to the step 128, and it is determined whether or not the velocity exceeds the threshold V₀.

If, at the step 128, it is determined that the negated value of velocity is less than or equal to V₀, the process advances to the step 144, the timers T1 and T2 are reset, and the process returns to the waiting state. If, at the step 128, it is determined that the negated value of velocity is greater than V₀, the process advances to the step 130 and the timer T1 is reset and started again (this corresponds to the point B3 in FIG. 8).

At the step 132, it is determined whether or not the next acceleration to be detected exceeds the threshold A₀. Here, if it is determined that the (positive) acceleration is less than or equal to A₀, the process advances to the step 134, and it is determined whether or not the timer Ti has exceeded the threshold T1₀.

If, at the step 134, it is determined that the timer T1 is greater than T1₀, the process advances to the step 144, the timers T1 and T2 are reset, and the process returns to the waiting state. If it is determined that the timer T1 is less than or equal to T1₀, the process returns to the step 132, and a velocity and an acceleration based on the next three-dimensional positional information to be input from the 3D measuring device 20 are detected and the process continues.

If, at the step 132, it is determined that the positive acceleration is greater than A₀, the process advances to the step 136, and it is determined whether or not the timer T1 is less than or equal to the threshold T1₀.

If, at the step 136, it is determined that the timer T1 is greater than T1₀, the process advances to the step 144, the timers T1 and T2 are reset, and the process returns to the waiting state. If it is determined that the timer T1 is less than or equal to T1₀, the process advances to the step 138, and it is determined whether or not the timer T2 is less than or equal to the threshold T2₀.

The timer T2 measures duration from the time clicking movement started. The threshold T2₀ is specified beforehand as the upperbound of a time required for double-clicking movement. Accordingly, it is possible to determine whether or not movement of the LED 10 corresponds to the double-clicking movement by comparing the timer T2 with the threshold T2₀.

If, at the step 138, it is determined that the timer T2 is greater than T2₀, the process advances to the step 144, the timers T1 and T2 are reset, and the process returns to the waiting state. If it is determined that the timer T2 is less than or equal to T2₀₁, the process advances to the step 140, and it is determined whether or not the velocity exceeds the threshold V₀.

If, at the step 140, it is determined that the (positive) velocity is less than or equal to V₀, the process advances to the step 144, the timers T1 and T2 are reset, and the process returns to the waiting state. If it is determined that the positive velocity is greater than V₀, the movement of the LED 10 corresponds to the pre-specified double-clicking movement described earlier. Accordingly, the process advances to the step 142, and the double-clicking processing is carried out (this corresponds to the point B4 in FIG. 8).

For double-clicking operation, similarly to the clicking operation, the command generation section 50 issues a command to the mouse driver 52 for executing a process associated with double-clicking movement. The OS 54, to which the command is input via the mouse driver 52, can interpret the command in the similar manner as in the case of a two-dimensional mouse, and executes a suitable process in response to the double-clicking movement.

After the step 142, the process advances to the step 144, the timers T1 and T2 are reset, and the process returns to the waiting state.

The double-clicking movement is not particularly limited to the form of FIG. 8, as long as the conditions of velocity, acceleration and time described above are satisfied. For example, a point along the z-axis at which the second clicking commences (i.e., point B2) is not necessarily the same position as the point along the z-axis at which the first clicking commenced (i.e., the point B0).

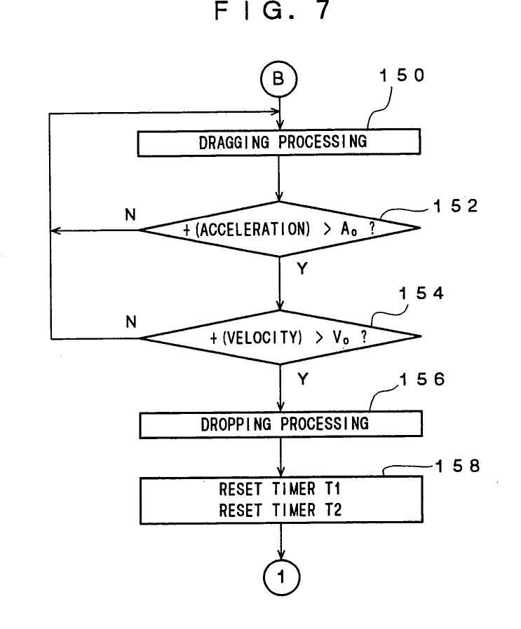

Meanwhile, if, at the step 108 of FIG. 5, it is determined that the timer T1 is greater than T1₀, the movement of the LED 10 corresponds to the pre-specified dragging movement. Accordingly, the process advances to the step 150 of FIG. 7, and the dragging process is carried out.

More specifically, similarly to the clicking operation, the command generating section 50 outputs a command to the mouse driver 52 for executing a process associated with dragging movement. The OS 54, to which the command is input via the mouse driver 52, interprets the command and executes suitable processing in response to the dragging movement.

Note that the dragging process is generally a process, which is carried out after the clicking process. For example, an object such as an icon or the like which has been selected by the clicking operation may be dragged (moved).

Subsequent to the step 150, the process advances to the step 152, and it is determined whether or not the acceleration exceeds the threshold A₀. If it is determined that the (positive) acceleration is less than or equal to A₀, the process returns to the step 150, and the dragging process continues. If it is determined that the positive acceleration is greater than A₀, the process advances to the step 154, and it is determined whether or not the velocity exceeds the threshold V₀.

If, at the step 154, it is determined that the (positive) velocity is less than or equal to V₀, the process returns to the step 150, and the dragging processing continues. When it is determined that the positive velocity is greater than V₀, the movement of the LED 10 corresponds to the pre-specified dropping movement. Accordingly, the process advances to the step 156, and the dropping process is carried out.

For the dropping process, similarly to the dragging process, the command generation section 50 outputs a command to the mouse driver 52 for executing a process associated with dropping movement. The OS 54, to which the command is input via the mouse driver 52, interprets the command and executes an appropriate process in response to the dropping movement.

Subsequent to the step 156, the process advances to the step 158, the timers T1 and T2 are reset, and the process returns to the waiting state.

At the step 108 of the process to input instructions described above, the threshold T1₀ is utilized for determining whether or not movement is a dragging operation. However, a threshold different from the threshold T1₀ may be provided, and the decision is made in accordance with this aforementioned threshold.

Now, in this system, a cursor appears on the display 42 for designating an object to which instructions for the execution of processes associated with movement such as clicking, double-clicking and the like are to be applied. (The object may include, for example, an icon, a folder, a button, an input position or the like.) A display processing routine for displaying the cursor on the display 42 is carried out simultaneously with the main routine of instruction inputting described above. The cursor is placed at a position according to size of the display 42 in accordance with the x and y co-ordinate included in the three-dimensional positional information that is measured by the 3D measuring device 20. An object which is displayed at a position pointed by the cursor (hereinafter called a designated position) is a target to be processed. In practice, the designated position by the cursor corresponds to the display position of the cursor, and is represented by the x and y co-ordinates.

It is possible to employ a current display routine, which is called from the OS for the cursor. However, a program of the display processing routine for displaying a cursor whose appearance can be defined by a user is incorporated into the program beforehand.

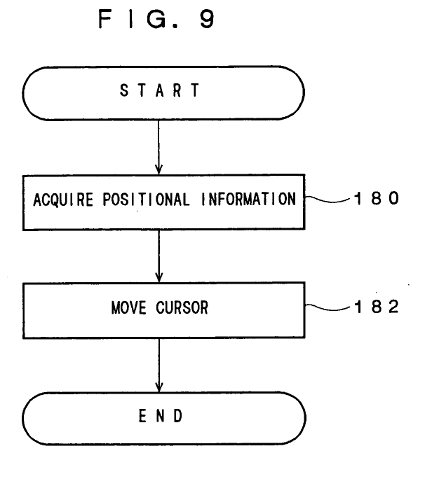

FIG. 9 is a flowchart showing the display processing routine. This display processing routine is executed at predetermined time intervals.

At the step 180, the three-dimensional positional information is acquired.

At step 182, the position of the cursor on the display moves in accordance with the positional information in the 3D. In the present embodiment, the position of the cursor on the display moves in accordance with the x co-ordinate and y co-ordinate included in the positional information in the 3D which is input from the 3D measuring device 20.

When the command generation section 50 outputs a command to the mouse driver 52, information about the designated position by the cursor is included in the command. Accordingly, if, for example, the movement of the LED 10 is a clicking operation, if an object such as an icon or the like is displayed at the designated position by the cursor, a process to select the icon is executed. Alternatively, if there is no object such as an icon or the like displayed thereat, a process to obtain the position itself designated by the cursor is executed. Further, if a button is displayed at the designated position by the cursor, a process for pressing the button is executed.

Thus, by displaying the cursor in accordance with the positional information in the 3D, instructions for processing of an object displayed at the designated position of the cursor can be input with ease.

As is clear from the flow of the instruction inputting processing described above, after a command is output and selection of an icon, position or the like is made (step 114), if the LED 10 moves slowly (‘no’ at the step 122 and then ‘yes’ at the step 124), the process returns to the waiting state. While the waiting state is maintained (‘no’ at the step 100), the selection state is maintained without alteration, and the cursor can be moved by the display processing routine described above.

As described above, the positional information in the 3D of the LED 10 is input, velocities and accelerations relating to the movement of the LED 10 are detected, it is determined whether or not the movement of the LED 10 corresponds to pre-specified movement on the basis of the detected velocities and accelerations, and subsequently execution of a process associated with the pre-specified movement is made. Thus, instructions can be input even without mechanical controls such as button controls and the like, and without relatively fine control.

Furthermore, the pre-specified movement is specified with the time duration. Thus, the time duration relating to movement of the LED 10 serves as grounds for decision in addition to the velocities and the accelerations. Therefore, it is possible to specify a greater number of movement as pre-specified movement.

Now, for the present embodiment, an example has been described in which the velocity and acceleration are detected using differences between z co-ordinates of the positional information. However, rather than the z co-ordinate, it is also possible to detect velocity and acceleration, for example, with respect to (x, y, z) co-ordinate. Further, for the present embodiment, an example has been described in which movement is decided on the basis of the velocity and acceleration detected from the z co-ordinate. However, the movement may be recognized on the basis of velocity and acceleration in another direction, for example, a vertical direction or a left-right direction from the point of view of the user. In such a case, the position of the cursor can be moved on the basis of co-ordinate in a two-dimensional plane, which is perpendicular to the aforementioned direction.

Furthermore, it is possible to arbitrarily alter the thresholds A₀, V₀, T1₀ and T2₀. For example, it is possible to provisionally mount the LED 10 on a hand or the like of a user and to measure typical movement (three-dimensional positions) of the LED 10, detecting velocities, accelerations, duration and the like relating to the movement of the user's hand, and then it can alter the settings of the threshold in accordance with the detected values. If the thresholds are customized in accordance with the user in this manner, usability is further improved.

Further again, for the present embodiment, an example has been described in which instructions are input by movement of the LED 10 alone. However, it is possible to separately provide, for example, a switch, a button or the like for inputting instruction besides the LED 10, and to appropriately employ, if necessary, inputting instruction by movement of the LED 10 and/or inputting instruction by mechanical control such as button-pressing or the like.

Further still, although description of such has not been included for the embodiment described above, it is possible to pre-specify movement corresponding to other movement such as, for example, mouse-down movement which is carried out by two-dimensional mouses (movement in which a button is kept depressed) and then to recognize such movement from velocities, accelerations and duration, and finally to issue a command to execute a corresponding process.

### THE SECOND EMBODIMENT

For the first embodiment described above, an example has been described in which movement is recognized on the basis of velocity and acceleration along the z-axis. However, in a case in which the x co-ordinate and y co-ordinate change during movement of the LED 10, even if conditions of velocity and acceleration along the z-axis are satisfied, the movement may not be recognized as any of pre-specified movement. In such case, each movement may be specified as movement in which the x and y co-ordinates do not change from the beginning to the end of the movement.

However, in practice, it is difficult for a user to move a hand while keeping x and y co-ordinate values fixed. Accordingly, for the present embodiment, an example is described in which the movement is provided with tolerance with respect to the x and y co-ordinates. Note that structure of an instruction inputting management system of the present embodiment is the same as in the first embodiment, and so descriptions thereof are omitted.

For example, for double-clicking movement, the steps shown in FIG. 10 can be employed instead of the step 142, in FIG. 6, of the first embodiment.

Following the step 140, at the step 160, it is decided whether or not x and y co-ordinates of the movement of the first clicking and x and y co-ordinates of the movement of the second clicking are within a pre-specified tolerance (for example, whether each co-ordinate is within ±5×(3/100) mm).

In FIG. 8, the x and y co-ordinates of the movement of the first clicking may be at the point B0 of FIG. 8, and may be at the point B1. Similarly, the x and y co-ordinates of the movement of the second clicking may be at the point B2, and may be at the point B3.

If, at the step 160, it is determined that the tolerance has been exceeded, the process advances to the step 144 without carrying out double-clicking process. Thus, in the case that fluctuations of the x co-ordinate and/or the y co-ordinate exceed the tolerance and the movement of the LED 10 follows a path with the form of a ‘W’, the movement of the LED 10 will not be regarded as double-clicking operation.

If, at the step 160, it is determined that the co-ordinates are within the tolerance, it is decided that the movement of the LED 10 is double-clicking operation, and double-clicking processing is carried out at the step 162.

By providing the movement with tolerance as described above, demands on a user are relatively alleviated.

Now, for the present embodiment, an example has been described in which it is decided whether or not the x and y co-ordinates at the point B0 of FIG. 8 (or the point B1) and at the point B2 (or the point B3) are within a tolerance. However, it is also possible to store x and y co-ordinates at the initial point B0, find respective x and y co-ordinates when passing through each of the points B1, B2, B3 and B4, and determine whether or not each of these co-ordinates is within the tolerance. If it is determined that the co-ordinate exceeds the tolerance at any point, the process immediately returns to the waiting state. Note that alternatively, when it is determined that the co-ordinate is outside the tolerance at the point B3 or the point B4, the process associated with clicking movement may have been kept carrying out.

Further, for the present embodiment, an example has been described in which tolerance is specified for the x and y co-ordinates for recognizing movement. However, it is also possible to specify tolerance ranges for velocities in the x and y directions for recognizing the movement. For example, together with the detection of velocities in the z direction, detection of velocities in the x and y directions may be employed for recognizing the movement of the LED 10.

In such a case, if the fluctuation of a velocity in the x or y direction exceeds a tolerance, it will be decided that the movement of the LED 10 does not correspond to the pre-specified movement.

Here, both the x,y co-ordinates and the velocities in the x and y directions may be employed for the decision, and setting of a tolerance for either one thereof may be employed for the same purpose.

Further, decisions using tolerance are not limited only to the double-clicking, and tolerance can be similarly provided for others. (clicking movement, dragging movement and so forth).

Furthermore, tolerances in the x and y directions may be specified such that an object is pointed by the user as a target to be processed (for example, an icon or the like) is considered as the target of processing even if the designated position by the cursor is slightly displaced from the object. Thus, execution of processing on a desired object can be instructed without fine control.

### THE THIRD EMBODIMENT

In the first embodiment described above, when the execution of processing associated with clicking movement, double-clicking movement or the like is instructed (the steps 114, 142, 150 and 156), execution of the processing is instructed for an object that is displayed at the position designated by the cursor. More specifically, when the command generation section 50 outputs a command to the mouse driver 52, positional information designated by the cursor is included in the command and output.

However, if the x and y co-ordinates are provided with tolerance as in the example illustrated for the second embodiment, cases in which the position designated the cursor changes during the movement of the LED 10 will occur.

In such a case, it is necessary to specify in advance which positional information of a plurality of designated positions during the movement is to be included in the command and output.

For example, in double-clicking movement, if a position of the LED 10 for the first clicking (a position at the point B0 or point B1 in FIG. 8) differs from a position of the second clicking (a position at the point B2 or point B3 in FIG. 8), it is necessary to specify in advance which positional information is to be output to the mouse driver 52. Ordinarily, it is often the case that the position of the first clicking is a position at which a user intends to designate. Therefore, information on that position may be included in the command (below, this is referred to as position-locking process). In such a case, it is required to have a process to preparatorily store the position information of the first clicking in a predetermined region of the RAM 38 before outputting the command, and to read the aforementioned positional information out from the RAM 38 for use at the time of outputting the command.

In such a case, just as long as fluctuations of the x and y co-ordinates are within their tolerances respectively, the position of the cursor on a display can be preparatorily fixed at the position of the first clicking, and this position can be identified by the user.

However, if continuous lines are being drawn in a drawing application or the like to create a drawing, it is usually preferable to utilize the most recent x and y co-ordinates. In such a case, the most recent x and y co-ordinates may be included in the command. In this case, unlike the case of position-locking, a special processing for reading out stored positional information is not required.

Position-locking may be pre-set or enabled depending on the status of a process being executed.

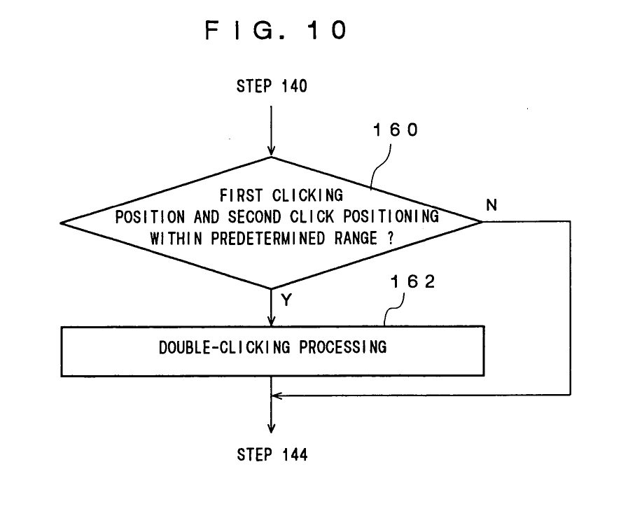

An example of the present embodiment, the aforementioned, will be described with reference to FIG. 11.

At the step 200, it is decided whether or not a process being executed at the personal computer 30 is a process for which position-locking is prohibited. For example, if, as described above, the process under execution is a drawing process in a drawing application, position-locking is prohibited.

If decision at the step 200 is positive, the most recent position information may be employed. Accordingly, the process advances to the step 204, and execution of processing corresponding to such a decision is instructed. In such a case, the command generation section 50 outputs a command to the mouse driver 52, which includes information about the most recent position.

If the decision at the step 200 is negative, at the step 202, positional information that has been preparatorily stored in the predetermined region of the RAM 38, that is, locked position (for example, in the case of double-clicking movement, positional information of the first clicking) is read out. At the step 204, execution of the processing corresponding to the determined movement is instructed. In this case, the command generation section 50 outputs a command to the mouse driver 52 which includes the aforementioned position information that has been read out.

The timing to store the locked position in the RAM 38 can be specified in advance. For example, in the case of double-clicking movement, any point from the point B0 to the point B4 can be specified for initiating storing the position.

By specifying information of some position during movement of the LED 10 and outputting a command as described above, even if a position designated by the cursor changes during the movement, underlying processing can be carried out appropriately.

### THE FOURTH EMBODIMENT

For the present embodiment, processing of a case in which pre-specified movement is specified with a state of quiescence for predetermined duration will be described. Specifically, rather than velocities, accelerations and the like, the movement is recognized on the basis of time duration.

Note that structure of an instruction inputting management system of the present embodiment is similar to the first embodiment, and so descriptions thereof are omitted.

Below, a case in which a pre-specified double-clicking movement is constituted by the clicking movement illustrated for the first embodiment and, after the clicking movement, a state of quiescence for predetermined duration is taken as an example and described. Note that in the present embodiment, similarly to the second embodiment, a tolerance is provided, and it is determined that the LED 10 is a state of quiescent if fluctuations of the position of the LED 10 are within the tolerance.

Processes in the present embodiment up to the clicking processing (the step 114 in FIG. 5) is the same as in the first embodiment, and so descriptions thereof are omitted. However, the present embodiment, the timer T2 is not used. Therefore, at the step 102 of FIG. 5, only the timer T1 is started.

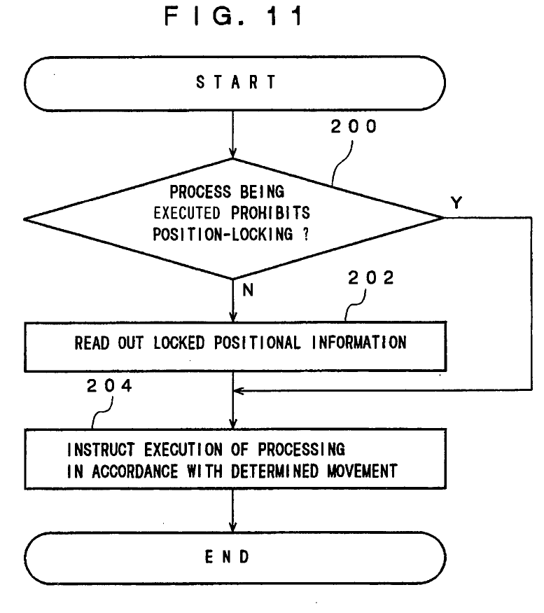

Processing of the present embodiment subsequent to the step 114 will be described using the flowchart of FIG. 12.

At the step 300, the timer T1 is reset and started again.

At the step 302, it is determined whether or not the timer T1 is less than a specified threshold of duration Tth. Tth is a threshold for the duration of quiescence, and is specified in advance.

If, at the step 302, it is determined that T1 is less than Tth, at the step 304 it is determined whether or not the LED 10 has moved from the first clicking position to a position beyond the tolerance. If this decision is negative, the process returns to the step 302. However, if this decision is positive, the movement of the LED 10 is in a state of non-quiescence. Accordingly, it is determined that the movement of the LED 10 does not correspond to the double-clicking movement, the process advances to the step 308, the timer T1 is reset and the process returns to the waiting state.

If, at the step 302, it is determined that T1 is greater than or equal to Tth, the LED 10 has been in the quiescent state for the predetermined duration. Accordingly, it is decided that the movement of the LED 10 corresponds to the double-clicking operation, the process advances to the step 306 and the double-clicking process is carried out.

After the step 306, the process advances to the step 308, the timer T1 is reset and the process returns to the waiting state.

As described above, states of quiescence with predetermined duration can be included in the pre-specified movement, and the movement of the LED 10 can be determined using time duration. As a consequence, amount of processing at the personal computer 30 can be reduced, and the movement of the LED 10 can be recognized more easily. In addition, user can do the operation described so far easily.

### THE FIFTH EMBODIMENT

For the fourth embodiment, an example has been described in which double-clicking movement is determined on the basis of time duration. For the present embodiment, an example, in which besides double-clicking, clicking movement is also determined on the basis of time duration, is described.

Note that structure of an instruction inputting management system of the present embodiment is similar to the first embodiment, and so descriptions thereof are omitted.

Here, a case in which an icon is displayed on the display 42 and the icon is designated as a subject of processing is taken as an example and described. Clicking movement is specified as a state, which is quiescent for predetermined duration, and double-clicking movement is specified as a state, after the clicking movement, which is quiescent for another predetermined duration. A state in which the LED 10 moves slowly after it has been determined that movement of the LED 10 is the clicking movement is specified as the beginning of the dragging movement, and a state in which a predetermined acceleration and velocity occur during the dragging movement is specified as the beginning of the dropping movement.

Note that it is possible for thresholds of the quiescence duration to be specified arbitrarily.

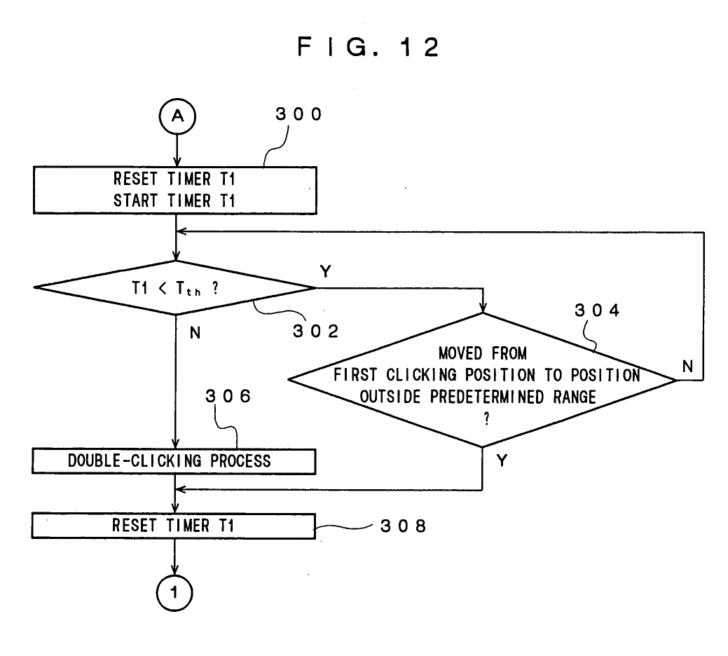

FIG. 13 is a flowchart showing the main routine of instruction inputting processing, which is carried out by the CPU 34 of the personal computer 30.

At the step 400, it is determined whether or not the position designated by the cursor coincides with a position of an icon on the display. Here, if it is determined that the position does not coincide, the process returns to the waiting state. If it is determined that the positions do coincide, the process advances to the step 402 and, after it has been determined that the positions coincide, it is determined whether or not the position of the cursor has spent predetermined duration in a non-moving state.

If, at the step 402, the decision is negative, the process returns to the waiting state.

If, at the step 402, the decision is positive, the movement of the LED 10 corresponds to the clicking movement. Accordingly, the process advances to the step 404 and the clicking process is carried out.

At the step 406, it is determined whether or not the position of the cursor on the display at the time of the clicking process coincides with a current position of the cursor on the display.

If the decision is positive at the step 406, it is determined at the step 408, whether or not predetermined duration has passed. At the step 408, if the decision is negative, the process returns to the step 406. If the judgment is positive at the step 408, a quiescent state of further predetermined duration has passed since the clicking operation, and the movement of the LED 10 corresponds to the double-clicking movement. Accordingly, the process advances to step 410 where double-clicking process is carried out.

On the other hand, if it is determined at the step 406 that the position of the cursor on the display at the time of click processing does not coincide with the current position of the cursor on the display, the process advances to the step 412, where it is determined whether or not the absolute value of a detected velocity is less than a threshold V₀ (the direction thereof may be either of the plus direction and the minus direction along the z-axis).

If, at the step 412, it is decided that the velocity is less than V₀, the LED 10 is in a state of moving slowly. Accordingly, the process advances to the step 414, where dragging process is carried out.

Then, at the step 416, it is determined whether or not acceleration exceeds a threshold A₀.

If, at the step 416, it is determined that the acceleration is less than or equal to A₀, the state in which the LED 10 is moving slowly is kept continuing. Accordingly, the process returns to the step 414 where the dragging process is continued.

If, at the step 416, it is determined that the acceleration is greater than A₀, the process advances to the step 418, where it is decided whether or not velocity exceeds the threshold V₀.

If, at the step 418, the velocity is less than or equal to V₀, the state in which the LED 10 is moving slowly remains the same. Accordingly, the process returns to the step 414 where the dragging process is continued.

If, at the step 418, it is decided that the velocity is greater than V₀, the movement of the LED 10 corresponds to the dropping movement. Accordingly, the process advances to the step 420, where dropping process is carried out.

Meanwhile, if it is decided at the step 412 that the velocity is greater than or equal to V₀, the movement of the LED 10 does not correspond to any movement. Accordingly, the process terminates without further action.

As described above, it is possible to select or open an icon at the position where the cursor, which is being displayed in accordance with movement of the LED 10, is placed for predetermined duration (a case of quiescence).

For the present embodiment, decision relating to the tolerances of the x and y co-ordinates have not been described. However, in the present embodiment too, tolerance may be provided similarly to the second embodiment, and a position of the cursor on the display during the clicking process is considered to coincide with a current position of the cursor on the display (in other words, that the cursor is quiescent) if a change in the position of the LED 10 is within the tolerance.

In such a case, a tolerance of fluctuations (of the x and y co-ordinates) in the position of the cursor on the display may be favorably set to, for example, (±5×3/100 mm). Further, for the present embodiment, an example, which employs velocity for recognizing the dragging movement has been described. It is also possible to set a tolerance for recognizing the clicking and double-clicking movement to the first tolerance, and to provide the second tolerance (which is a larger than the first), separately from the first tolerance, for recognizing the dragging movement. Hence, a state in which the cursor moves beyond the first tolerance but remains in the second tolerance for predetermined duration may be determined as dragging movement.

Further again, when the LED 10 moves in the direction where the z co-ordinate decreases within predetermined duration, that is, where the LED 10 moves in a direction to approach the 3D measuring device 20, commencing dragging is also favorable.

It is possible to write algorithms consisting of a sequence of decisions related to duration, accelerations and velocities (or just duration) as described above.

Accordingly, amount of processing time at the personal computer 30 can be reduced, and the movements of the LED 10 can be recognized easily. A user can easily handle the operation described so far.

### THE SIXTH EMBODIMENT

For the present embodiment, an example will be described in which information of a time series of three-dimensional positions (below referred to as time series patterns), which represent clicking movement, double-clicking movement and the like, is preparatorily stored in the HDD 46 or the ROM 36, and time series patterns are employed for recognizing the movement of the LED 10. Structure of an instruction inputting management system of the present embodiment is similar to the first embodiment, and so descriptions thereof are omitted.

The command generation section 50 inputs positional information in the 3D that has been measured from the 3D measuring device 20 at predetermined time intervals. The command generation section 50 proceeds to preparatorily store the positional information in a sequence at a predetermined region of the RAM 38, and thus obtains a time series of positional information of the LED 10.

The region at which the positional information is stored may include, for example, a ring-like data structure, i.e., data are linked circularity. Newly obtained three-dimensional positional information is overwritten to the oldest data stored in the aforementioned ring-like data structure.

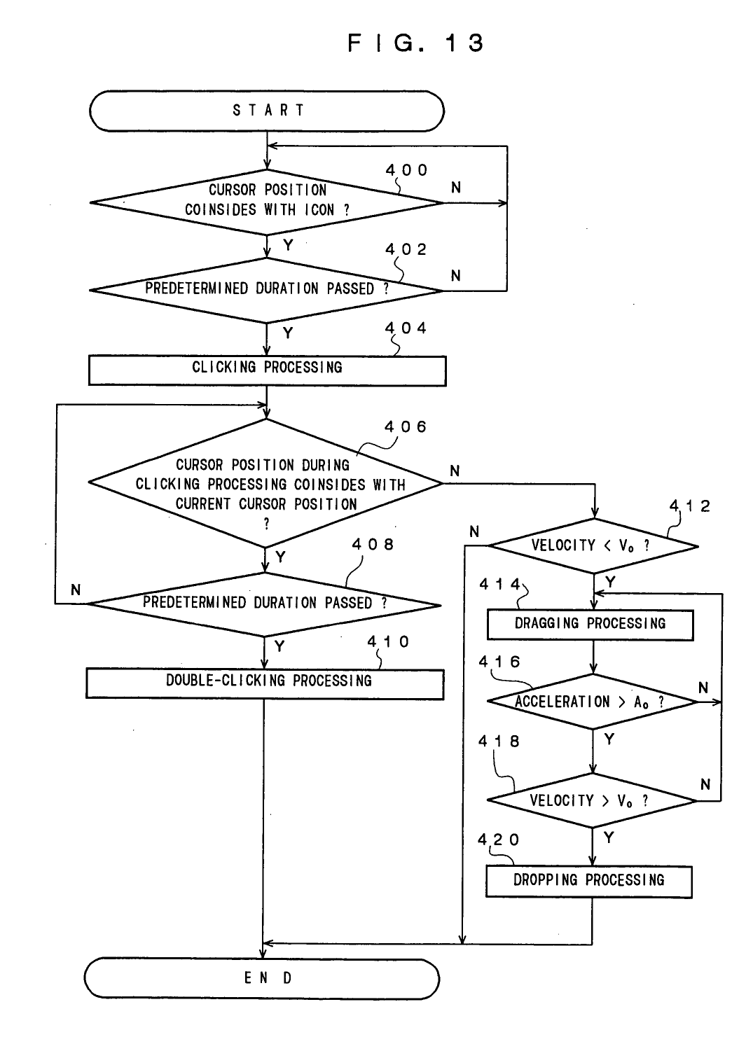

FIG. 14 is a flowchart showing a processing routine for storing positional information, which is carried out at the predetermined time intervals.

At the step 500, the three-dimensional positional information is acquired from the 3D measuring device 20.

At the step 502, the acquired three-dimensional positional information is overwritten to the region of the RAM 38 at which the oldest data is stored.

Thus, data of a time series of the positional information in the 3D is obtained.

FIG. 15 is a flowchart showing processing routine for implementing an instruction inputting process using the time series patterns, which is carried out at the predetermined time intervals. Similarly to the first embodiment, a program of this instruction inputting processing routine is stored in a storage medium such as the HDD 46 or the like, and is executed by the CPU 34.

At the step 600, a time series of three-dimensional position, for predetermined duration Ta from the starting time, is acquired from the RAM 38.

At the step 602, a counter p is set to zero. p is a counter for sequentially matching all of the pre-stored time series patterns with a path represented by the acquired positional information.

At the step 604, p is incremented by one.

At the step 606, a p-th stored time series pattern is compared with a path represented by the acquired position information.

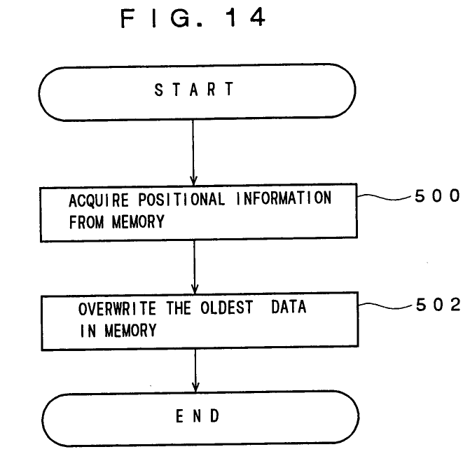

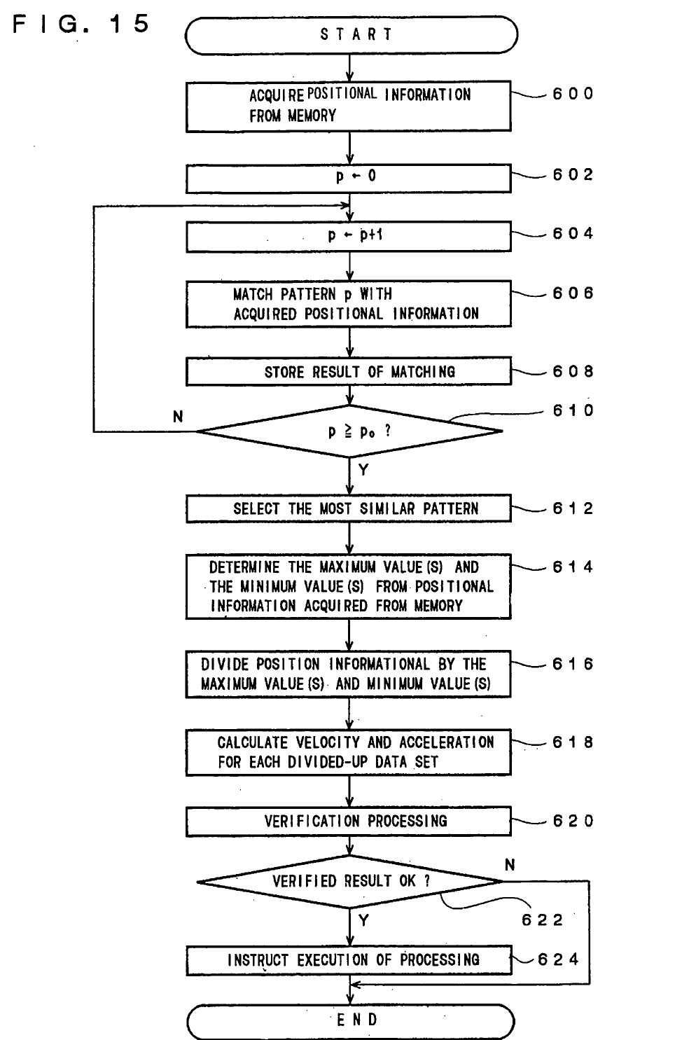

Examples of pre-stored time series patterns are shown in FIGS. 16 and 17.

FIG. 16 is an example of a time series pattern representing clicking movement, and FIG. 17 is an example of a time series pattern representing double-clicking movement. In the present embodiment, the path pattern that has been acquired beforehand is matched with, for example, these newly input time series patterns, and it is determined whether or not movement of the LED 10 corresponds to any of the movement that the time series patterns represent.

At the step 608, results of matching are stored at a predetermined region of the RAM 38.

For example, similarities can be numerically expressed by employing techniques such as scaling, the least squares method and the like, and such similarities may be stored as the results of matching with the p-th time series pattern.

At the step 610, the counter p is compared with a total number of the pre-stored time series patterns p₀, and it is decided whether or not p is greater than or equal to p₀. If p is determined to be less than p₀ the process returns to the step 604, p is incremented, and the processing is repeated to match the pre-stored time series pattern with the path represented by the acquired positional information.

If it is determined that p is greater than or equal to p₀ in step 610, matching of the path represented by the input positional information with all of the pre-stored time series patterns has been completed. Accordingly, the process advances to the step 612, and the time series pattern, which has the highest similarity, is selected from all of the results of matching.

Then, at the step 614, maximum values and minimum values are determined from the input positional information. Specifically, if the selected time series pattern is the time series pattern of clicking movement, one maximum value and one minimum value are determined, and if the selected time series pattern is the time series pattern of double-clicking movement, one maximum value and two minimum values are determined.

At the step 616, the time series of positional information is divided up by reference to the maximum value and minimum values. For example, if the movement of the LED 10 is the movement shown in FIG. 8, the time series of positional information is divided into four portions by the two minimum values and one maximum value of the z co-ordinates. That is, the time series of positional information is divided into four data sets: from the point B4 to the point B3; from the point B3 to the point B2; from the point B2 to the point B1; and from the point B1 to the beginnig of the time series of positional information.

At the step 618, velocity and acceleration are calculated for each of the divided-up data sets. Although the signs of the velocities and accelerations differ in accordance with movement directions of the LED 10, it is sufficient to consider only their absolute values here.

Although various methods can be considered for calculating the velocities, as illustrated in the first embodiment, the velocities may be found by dividing differences between z co-ordinates of the divided-up data by respective underlying time difference. It is also possible to assign an arbitrary time frame, find a difference between a z co-ordinate value at an arbitrary instant and a z co-ordinate value at an instant which is offset from the first instant by an amount corresponding to the time frame, and divide this difference by the time frame to find the velocity.

Accelerations can be found as follows. Within the divided-up data set, take a pairwise difference among the connective positional data along the time axis. This creates a new time series of data. Then, an arbitrary time frame Tm along the time axis is applied to the thus-created time series data, a difference between the time series data at an arbitrary instant and the time series data at an instant which is offset from the first instant by the frame Tm is found, and this difference is divided by the frame Tm to find an acceleration.

Note that methods for finding velocities and accelerations are not particularly limited to these mentioned heretofore, and any method may be employed.

at step 620, the movement of the LED 10 is verified on the basis of the velocities and accelerations that have been found.

Specifically, it is determined whether or not the accelerations and velocities of the divided-up data sets exceed pre-specified threshold. Here, if it is determined that even one of the thresholds has not been exceeded, the result of verification is negative. If it is determined that all of the accelerations and velocities have exceeded the thresholds, the result of verification is positive.

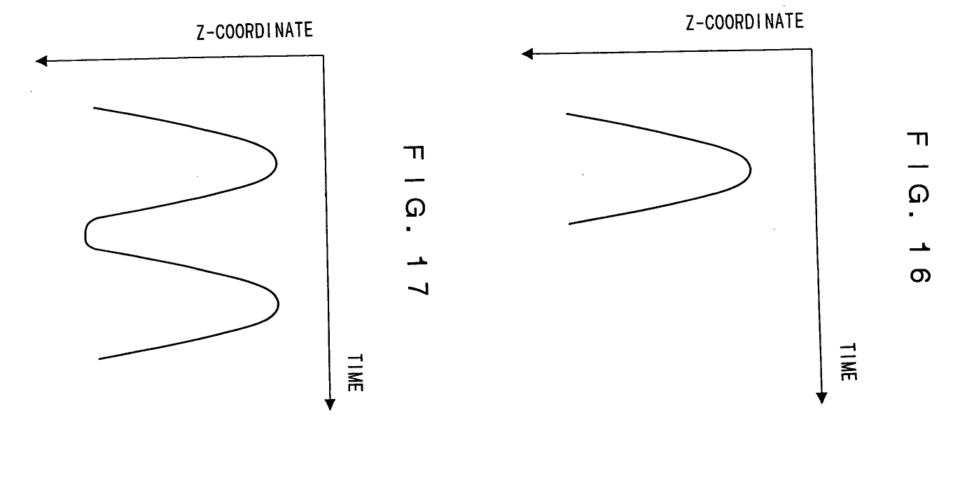

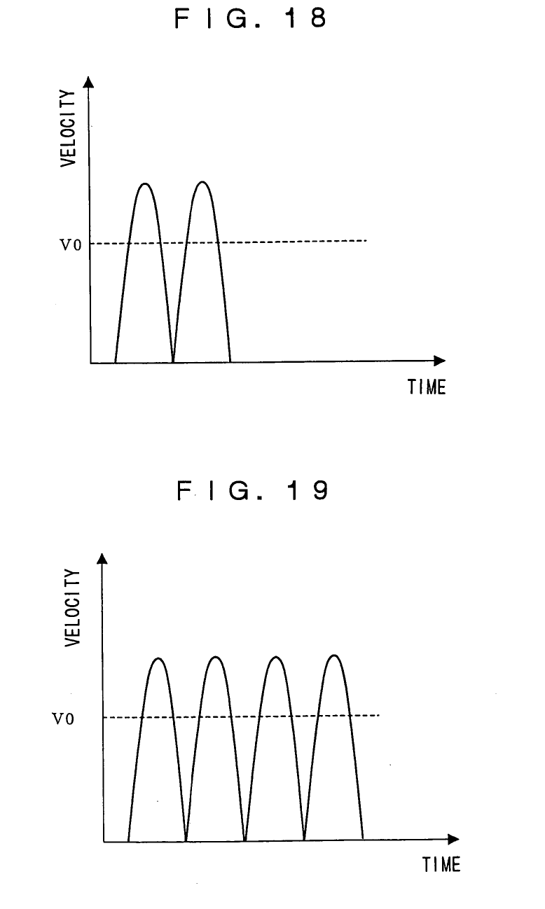

FIG. 18 shows an example of velocity conditions in clicking movement, and FIG. 19 shows an example of velocity conditions in double-clicking movement. The velocities are represented as absolute values in these drawings. The level V₀ shown in the drawings is a threshold of velocity. The velocities are shown in simple hill-shaped forms in order to facilitate understanding of the main point of this explanation.

As illustrated, the result of verification for a clicking will be positive if each of velocities for two divided-up data sets exceeds respective the threshold, and the result of verification for a double-clicking will be positive if each of velocities for four divided-up data sets exceeds respective threshold. A time series of acceleration may also be used in a similar manner.

At the step 622, it is decided whether or not the verification result is positive. If it is determined that the verification result is negative, the movement of the LED 10 does not correspond to any of the movement represented by the selected time series patterns. Accordingly, the process terminates without further action.

If, at the step 622, it is determined that the verification result is positive, the process advances to the step 624, and execution of processing associated with the movement represented by the selected time series pattern is instructed.

Details of processing at the step 624 are the same as at the steps which execute the processes associated with clicking movement, double-clicking movement and the like in the first embodiment (steps 114, 142, 150 and 156). Accordingly, descriptions thereof are not given here.

If, while the sequence of velocities and accelerations of the divided-up data sets are being calculated and compared with their thresholds, it is determined that a threshold has been exceeded for one of the divided-up data sets, the processing may be terminated immediately, without calculating velocities and accelerations for the remaining divided up data sets.

A method for selecting a time series pattern is not limited to the example described above. A method illustrated below can also be applied. Characteristics of time series patterns that represent, for example, clicking movement, double-clicking movement and the like are stored in advance.

For example, for the time series pattern that represents clicking movement, a characteristic that only one minimum in z co-ordinate is present can be stored in advance. Further, for the time series pattern that represents double-clicking movement, a characteristic that two consecutive local minimum in z co-ordinate are present can be pre-stored.

Accordingly, for matching, it is decided whether or not the path represented by the acquired positional information has these characteristics. Specifically, if it is determined that only one minimum is present in a path represented by an acquired time series of positional information, the time series pattern representing the clicking movement can be selected, and if two consecutive local minimum are present, the time series pattern representing the double-clicking movement can be selected.

Thus, because the movement of the LED 10 are tested using the time series patterns in addition to the velocities and accelerations, movement can be tested with higher accuracy and overall processing time is reduced.

### THE SEVENTH EMBODIMENTS

For the present embodiment, an example will be described in which, rather than carrying out processing to calculate velocities and accelerations and perform verification, movement of the LED 10 is recognized only by a time series pattern. Structure of an instruction inputting management system of the present embodiment is similar to the first embodiment, and so descriptions thereof are omitted.

Here, the region in which the 3D measuring device 20 recognizes light emissions of the LED 10 is defined as a cuboid adjacent to the 3D measuring device 20.

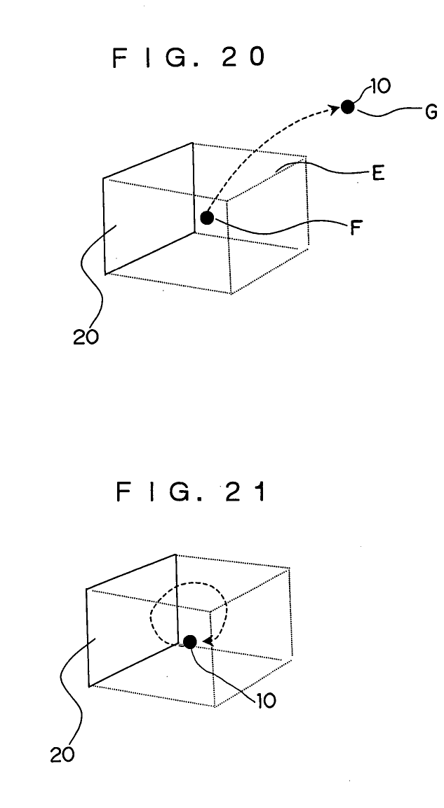

FIG. 20 is an example of a time series pattern. FIG. 20 shows movement from a central vicinity (F) of the recognition region, as defined above, which linearly passes beyond the upper face (E) of the cuboid, or the left face or right face thereof, and moves to a non-recognition region (G).

Such a time series pattern has following characteristics.

Changes in the time series data of the x, y and z co-ordinates are monotonic, and because the LED 10 moves outside the recognition region, the 3D measuring device 20 generates eventually a state of recognition failure.

Accordingly, in the case that the 3D measuring device 20 presents movement having these characteristics, a decision corresponding to this time series pattern is made.

When such a time series pattern is recognized, the present system may, for example, be shut down.

FIG. 21 is also an example of a time series pattern. FIG. 21 shows movement that the LED 10 temporarily stops in the recognition region, and then draws a circular arc within the recognition region.

This movement drawing a circle (for example, movement which moves from below to above and then returns downward while rotating rightward) has a characteristic that a subsequent stopping position falls within a predetermined tolerance from the initial position of temporary stopping.

Further, if the upper left corner of the display toward the 3D measuring device 20 being attached on the top of the former serves as the origin and the xyz co-ordinate system is defined such that a direction rightward from the origin is the positive direction along the x axis, a downward direction is the positive direction along the y axis, and a direction toward the user is the positive direction along the z axis, the following characteristics are presented.

Between the two stopping positions, there is a monotonic decrease, the minimum, and a monotonic increase in the y co-ordinate.

Between the two stopping positions, there is a monotonic decrease, the minimum, a monotonic increase, the maximum, and a monotonic decrease in the x co-ordinate.

Therefore, in this region, if the x co-ordinates and y co-ordinates in the data set, simultaneously satisfy these characteristics, it is found that the observed set of data is considered as the time series of the prescribed movement. When this time series pattern is recognized, a process for, for example, enlarging an entire picture on the display is executed.

Further, a time series pattern in which a direction of describing turning leftward in a circle may be separately defined for instructing the execution of a process to return the display to the original state. Furthermore, the enlargement or the panning of a picture is made respectively with various predetermined magnification rate or reduction rate depending on how and how many times a circle is turned. Finally, the circle movement may be set to be movement in the x-z plane rather than movement in the x-y plane.

Now, when a circle is drawn in the in the air, it is relatively difficult to return a hand accurately to the initial stopping position. Therefore, it is favorable to provide a suitable tolerance of the difference between the initial stopping position and the subsequent stopping position.

### THE EIGHTH EMBODIMENT

For the present embodiment, an example will be described in which a condition of a cursor on the display is changed and/or sound is generated in accordance with the speed of the cursor, such that a user can recognize states of movement of the LED 10.

In the present embodiment, an extended cursor is displayed as well as the ordinary cursor.

Now, the extended cursor will be described. On a desktop appearing on the display 42 of the personal computer 30, a small region including the point at which the ordinary cursor designates an object (corresponding to the designation position mentioned earlier) is marked by a circle or the like, and is displayed as a separate window.

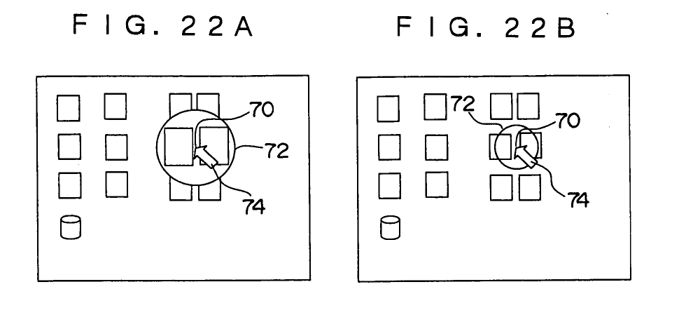

As shown in FIGS. 22A and 22B, the interior of a circle centered at the designated position 70 is displayed as a window (the extended cursor) 72. The ordinary cursor 74 is displayed inside the extended cursor 72, and more specifically, is superimposed at the central portion thereof. The OS 54 employs the image driver 56 to display this extended cursor 72.

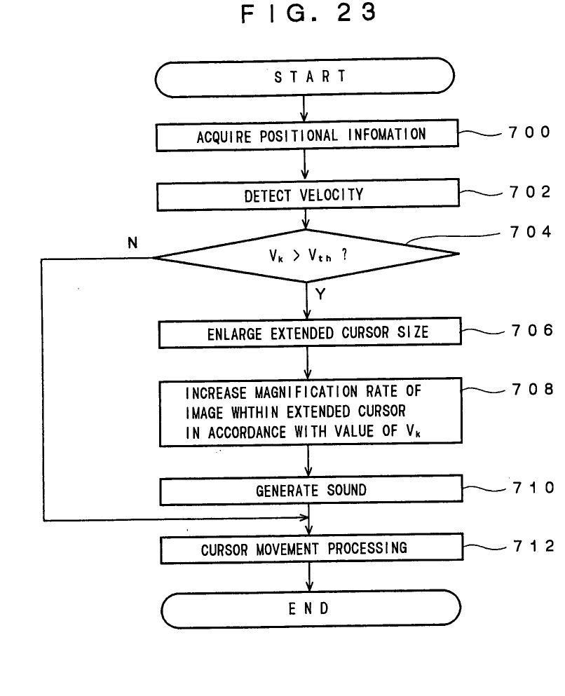

In the present embodiment, instead of the display processing routine that has been described in the first embodiment, the processing routine shown in FIG. 23 is executed. This routine is executed at predetermined time intervals.

At the step 700, positional information in the 3D is acquired.

At the step 702, velocity is detected. A detection method is the same as that in the first embodiment, so a description thereof is not given here.

At the step 704, it is determined whether or not the detected velocity Vk exceeds a pre-specified threshold Vth. Here, if a decision is positive, the process advances to the step 706, and the size of the extended cursor 72 is enlarged. Then, at the step 708, a magnification ratio of an image inside the extended cursor 72 is updated in accordance with the value of the detected velocity Vk. Further, at the step 710, sound is generated by the speaker 44 in accordance with the velocity.

FIG. 22A shows a state in which the size of the extended cursor 72 is enlarged and the magnification ratio of the image inside the extended cursor 72 has been increased.

At the step 712, the position of the ordinary cursor 74 and the extended cursor 72 is moved in accordance with the three-dimensional positional information.

On the other hand, if the decision in step 704 is negative, the process advances to the step 712 and carries out only cursor movement processing.

FIG. 22B shows a state of the extended cursor when velocity is low. As shown in this drawing, a radius of the extended cursor 72 is at the minimum, and the image inside the circle is the same as the background. That is, the magnification ratio is 1.

Thus, the extended cursor 72 is displayed with a small size when speed is not sufficient, and the size of the extended cursor 72 becomes larger in accordance with increases in speed. Consequently, the user can recognize the speed while moving a hand on which the LED 10 is mounted. The varying size of the extended cursor helps a user input instructions easily.

The display routine may work such that the extended cursor 72 being not usually displayed, is displayed when the velocity is at or above a predetermined value, and is not displayed when the velocity greatly decreases. Conversely, it is possible for the extended cursor 72 to be displayed when the velocity is at or below a predetermined value, and not displayed when the velocity is greatly increased.

Further, if particular sound is generated in accordance with speed, as described for the step 710 above, such sound helps user input more easily, in particularly those with poor eyesight.

Further again, property of color, such as phases of color of the ordinary cursor 74 and the extended cursor 72 may be changed in accordance with speed. Moreover, it is possible for specifications of such changes in display conditions, and in size of the extended cursor (for example, a radius or the like), to be arbitrarily specified by the user.

As described for each embodiment hereabove, movement of the LED 10 are recognized on the basis of velocities and accelerations relating to the movements of the LED 10. Consequently, in a region where the 3D measuring device 20 can recognize light emissions of the LED 10, it is possible to control operations such as clicking, double-clicking, dragging and the like to be carried out without employing a mechanical mechanism, regardless of distance from the 3D measuring device 20.

The present invention is not limited to those in the embodiments described above. Rather than operation of a personal computer, it is possible to apply the present invention to, for example, operations of a touch panel used for a photocopying machine, an ATM of a banking institution or the like. Accordingly, operations of the touch panel can be carried out without touching a screen.

Furthermore, it is possible to apply the present invention to controlling on/off switches and the like.

What is claimed is:

1. An instruction inputting device comprising:
an input component which inputs positional information of a light-emitting component, which is measured on the basis of light-reception conditions of light emitted from the light-emitting component, being mountable on a user;
a detection component which, on the basis of the input positional information, detects a physical quantity of speed in accordance with movement of the light-emitting component;
a decision making component which, on the basis of the physical quantity of the detected speed, decides whether or not the movement of the light-emitting component corresponds to pre-specified movement; and
an instruction component which, if it is decided that the movement of the light-emitting component corresponds to the pre-specified movement, issues a command to execute a process associated with the pre-specified movement.

2. The instruction inputting device of claim 1, further comprising a storage component which stores movement information representing a plurality of distinctively pre-specified movement,
wherein the decision making component includes:
a selection component which selects information of at least one movement that corresponds to the movement of the light-emitting component from the stored information of the plurality of movement; and
a verification component which verifies whether or not the movement of the light-emitting component corresponds to movement represented by the movement information that has been selected by the selection component.

3. The instruction inputting device of claim 2, wherein
the movement information comprises information of a time series of positions,
the input component inputs the positional information to form a time series, and
the selection component selects the information of at least one movement on the basis of the positional information that has been input to the time series.

4. The instruction inputting device of claim 2, wherein the verification component verifies whether or not the movement of the light-emitting component corresponds to the movement represented by the movement information selected by the selection component on the basis of the detected physical quantity of speed.

5. The instruction inputting device of claim 1, wherein the physical quantity of speed comprises at least one of acceleration and velocity according to the movement of the light-emitting component.

6. The instruction inputting device of claim 1, further comprising:
a display component which displays information of a target for which execution of processing is to be instructed and designation information for designating the target information; and
a display control component which controls the display component such that a position of the designation information changes in accordance with a change of the input positional information,
wherein, if it is decided that the movement of the light-emitting component corresponds to the pre-specified movement, the display component instructs an execution of the processing that is associated with the pre-specified movement for the target information that is designated by the designation information.

7. The instruction inputting device of claim 6, wherein the instruction component instructs an execution of the processing that is associated with the pre-specified movement for the target information that is designated by the designation information, during the movement of the light-emitting component for which it has been decided that the movement of the light-emitting component corresponds to the pre-specified movement.

8. The instruction input device of claim 1, wherein the pre-specified movement comprises movement which reciprocates once in a predetermined direction.

9. The instruction inputting device of claim 8, wherein
the pre-specified movement includes the movement which reciprocates once in a predetermined direction, within predetermined duration,
the instruction inputting device further includes a calculation component which calculates duration relating to the movement of the light-emitting component, and
the decision making component decides whether or not the movement of the light-emitting component is the pre-specified movement on the basis of the detected physical quantity of speed and the duration calculated by the calculation component.

10. The instruction inputting device of claim 1, wherein the pre-specified movement comprises movement which reciprocates twice in a predetermined direction.

11. The instruction inputting device of claim 10, wherein
the pre-specified movement includes the movement which reciprocates twice in a predetermined direction, within predetermined duration,
the instruction inputting device further includes a calculation component which calculates duration relating to the movement of the light-emitting component, and
the decision making component decides whether or not the movement of the light-emitting component is the pre-specified movement on the basis of the detected physical quantity of speed and the duration calculated by the calculation component.

12. The instruction inputting device of claim 1, wherein the pre-specified movement comprises movement which moves in a predetermined direction and, after moving in the predetermined direction, further moves in at least one of the predetermined directions, a direction perpendicular to the predetermined direction and a direction between these aforementioned two directions.

13. The instruction inputting device of claim 12, wherein
the pre-specified movement includes the movement which moves in a predetermined direction and, after moving in the predetermined direction, further, after predetermined duration has passed, moves in the at least one of the predetermined directions, a direction perpendicular to the predetermined direction and the direction between these aforementioned two directions,
the instruction inputting device further includes a calculation component which calculates duration relating to the movement of the light-emitting component, and
the decision making component decides whether or not the movement of the light-emitting component is the pre-specified movement on the basis of the detected physical quantity of speed and the duration calculated by the calculation component.

14. The instruction inputting-device of claim 1, wherein the pre-specified movement comprises movement which moves in a direction opposite to a predetermined direction.

15. The instruction inputting device of claim 1, wherein the pre-specified movement comprises a state of being quiescent.

16. The instruction inputting device of claim 15, wherein
the pre-specified movement includes the state of being quiescent, for predetermined duration,
the instruction inputting device further includes a calculation component which calculates duration relating to the movement of the light-emitting component, and
the decision making component decides whether or not the movement of the light-emitting component includes the state of being quiescent for the predetermined duration on the basis of the detected physical quantity of speed and the duration calculated by the calculation component.

17. The instruction inputting device of claim 1, further comprising a calculation component which calculates duration relating to the movement of the light-emitting component, wherein the decision making component decides whether or not the movement of the light-emitting component corresponds to the pre-specified movement on the basis of the detected physical quantity of being speed and the calculated duration.

18. The instruction inputting device of claim 1, wherein, when the decision making component decides whether or not the movement of the light-emitting component corresponds to the pre-specified movement, the decision making component applies a tolerance to at least one of the movement of the light-emitting component and the pre-specified movement.

19. The instruction inputting device of claim 6, wherein the display control component controls so as to alter a display condition of the designation information in accordance with the detected physical quantity of speed.

20. The instruction inputting device of claim 19, wherein the display control component controls so as to alter at least one of shape, size and color of the designation information in accordance with the detected physical quantity of speed.

21. The instruction inputting device of claim 20, wherein the display control component controls so as to alter a size of target information that is displayed within a predetermined distance from the position of the designation information.

22. The instruction inputting device of claim 1, further comprising:
a sound generation component for generating sound; and
a sound output control component which controls the sound generation component so as to alter a sound generation condition in accordance with the detected physical quantity of speed.

23. An instruction inputting method comprising the steps of:
(a) measuring positional information of a light-emitting component on the basis of light-reception conditions of light emitted from the light-emitting component, which is mountable on a user;
(b) inputting the positional information measured in the step (a);
(c) on the basis of the input positional information, detecting a physical quantity of speed in accordance with movement of the light-emitting component;
(d) on the basis of the detected physical quantity of speed, deciding whether or not the movement of the light-emitting component corresponds to pre-specified movement; and
(e) if it is decided that the movement of the light-emitting component corresponds to the pre-specified movement, instructing an execution of processing that is associated with the pre-specified movement.
